(19) United States
(12) Patent Application Publication
(10) Pub. No.: US 2026/0266615 A1
(43) Pub. Date: Sep. 10, 2026

(54) GUIDANCE SYSTEM AND GUIDANCE METHOD

(71) Applicant: Mitsubishi Electric Corporation, Tokyo (JP)

(72) Inventors: Masaaki SUGIMURA, Tokyo (JP); Ryu MAKABE, Tokyo (JP); Hiroshi OTSUKA, Tokyo (JP); Akiko MORI, Tokyo (JP)

(73) Assignee: Mitsubishi Electric Corporation, Tokyo (JP)

(21) Appl. No.: 19/163,643

(22) PCT Filed: Mar. 19, 2024
(86) PCT No.: PCT/JP2024/010642

§ 371 Date: Sep. 9, 2025

(30) Foreign Application Priority Data
Mar. 20, 2023 (WO) PCT/JP2023/010999

(51) Int. Cl. G01C 21/34; G06Q 50/47; G06V 40/20

(52) U.S. Cl. CPC G01C 21/3438; G01C 21/3476; G06Q 50/47; G06V 40/20

(57) ABSTRACT

A guidance system includes: a user specifying unit configured to, based on an image captured by an imaging device configured to image a user near a guidance map that provides guidance about a guidance target, specify the user; and a guidance presentation unit configured to, based on interest information that represents a degree of interest of the user, that is acquired from an interest information storage unit configured to store the interest information, and that corresponds to the user specified by the user specifying unit, and an attribute of an area within a range of the guidance target, which is acquired from an attribute information storage unit configured to store the attribute for each area, cause the guidance map to output guidance information about the area within the range of the guidance target having an attribute with a higher degree of interest of the specified user.

### TECHNICAL FIELD

The present disclosure relates to a guidance system and a guidance method.

### BACKGROUND ART

In recent years, a guidance system that provides guidance tailored to a specific individual has been known (for example, see Patent Document 1). In such a guidance system in the related art, in order to specify an individual, an image including a person and positional information with which the image is acquired are collected, analysis is performed based on the collected data, and guidance is output in advance of the movement of the person.

### CITATION LIST

### Patent Document

Patent Document 1: Japanese Unexamined Patent Application, First Publication No. 2019-185236

### SUMMARY OF INVENTION

### Technical Problem

In the above-described guidance system in the related art, the positional information is essential. Means for acquiring the positional information is, for example, a global positioning system (GPS). In general, the GPS can acquire the positional information outdoors by using a device having a GPS function. However, in urban areas, there are many structures, and thus there is a probability that the positional information cannot be acquired by the GPS, and the guidance tailored to a user cannot be provided.

The present disclosure has been made in order to solve the above-described issues, and an object of the present disclosure is to provide a guidance system and a guidance method that can provide appropriate guidance tailored to a user without requiring means for acquiring positional information.

### Solution to Problem

In order to achieve the above-described object, an aspect of the present disclosure provides a guidance system including: a user specifying unit configured to, based on an image captured by an imaging device configured to image a user near a guidance map that provides guidance about a guidance target, specify the user; and a guidance presentation unit configured to, based on interest information that represents a degree of interest of the user, that is acquired from an interest information storage unit configured to store the interest information, and that corresponds to the user specified by the user specifying unit, and an attribute of an area within a range of the guidance target, which is acquired from an attribute information storage unit configured to store the attribute for each area, cause the guidance map to output guidance information about the area within the range of the guidance target having an attribute with a higher degree of interest of the specified user.

Another aspect of the present disclosure provides a guidance method of a guidance system configured to output guidance information to a guidance map that provides guidance about a guidance target, the guidance method including: via a user specifying unit, based on an image captured by an imaging device configured to image a user near the guidance map, specifying the user; and via a guidance presentation unit, based on interest information that represents a degree of interest of the user, that is acquired from an interest information storage unit configured to store the interest information, and that corresponds to the user specified by the user specifying unit, and an attribute of an area within a range of the guidance target, which is acquired from an attribute information storage unit configured to store the attribute for each area, causing the guidance map to output the guidance information about the area within the range of the guidance target having an attribute with a higher degree of interest of the specified user.

### Advantageous Effects of Invention

According to the present disclosure, it is possible to provide appropriate guidance tailored to the user without requiring the means for acquiring the positional information.

### BRIEF DESCRIPTION OF DRAWINGS

FIG. 1 A configuration diagram showing an example of a guidance system according to a first embodiment.

FIG. 2 A functional block diagram showing an example of the guidance system according to the first embodiment.

FIG. 3 A diagram showing a data example of an attribute information storage unit according to the first embodiment.

FIG. 4 A diagram showing a disposition example of an imaging device in an elevator according to the first embodiment.

FIG. 5 A diagram showing a disposition example of an imaging device in an escalator according to the first embodiment.

FIG. 6 A diagram showing a disposition example of an imaging device on stairs according to the first embodiment.

FIG. 7 A diagram showing a determination example of a floor determination unit according to the first embodiment.

FIG. 8 A diagram showing a data example of a guidance map storage unit according to the first embodiment.

FIG. 9 A diagram showing a data example of an interest information storage unit according to the first embodiment.

FIG. 10 A diagram showing a disposition example of a camera in a guidance map according to the first embodiment.

FIG. 11 A flowchart showing an example of an arrival floor determination process of the guidance system according to the first embodiment in a case where the elevator is used.

FIG. 12 A flowchart showing an example of an arrival floor determination process of the guidance system according to the first embodiment in a case where the escalator is used.

FIG. 13 A flowchart showing an example of a process of acquiring behavior information and interest information of the guidance system according to the first embodiment.

FIG. 14 A flowchart showing an example of a detailed process of step S306 in FIG. 13.

FIG. 15 A diagram showing an example of a guidance process of the guidance system according to the first embodiment.

FIG. 16 A flowchart showing details of the guidance process of the guidance system according to the first embodiment.

FIG. 17 A functional block diagram showing an example of a guidance system according to a second embodiment.

FIG. 18 A diagram showing an example of a guidance process of the guidance system according to the second embodiment.

FIG. 19 A functional block diagram showing an example of a guidance system according to a third embodiment.

FIG. 20 A configuration diagram showing an example of a guidance system according to a fourth embodiment.

FIG. 21 A configuration diagram showing an example of a guidance system according to a fifth embodiment.

FIG. 22 A functional block diagram showing an example of the guidance system according to the fifth embodiment.

FIG. 23 A diagram showing an example of an operation of the guidance system according to the fifth embodiment.

FIG. 24 A configuration diagram showing an example of a guidance system according to a sixth embodiment.

FIG. 25 A functional block diagram showing an example of the guidance system according to the sixth embodiment.

FIG. 26 A diagram showing an example of an operation of the guidance system according to the sixth embodiment.

FIG. 27 A diagram showing another example of the operation of the guidance system according to the sixth embodiment.

FIG. 28 A first diagram showing a hardware configuration of each device of the guidance system according to the embodiment.

FIG. 29 A second diagram showing the hardware configuration of each device of the guidance system according to the embodiment.

### DESCRIPTION OF EMBODIMENTS

Hereinafter, a guidance system and a guidance method according to an embodiment of the present disclosure will be described with reference to the drawings.

### First Embodiment

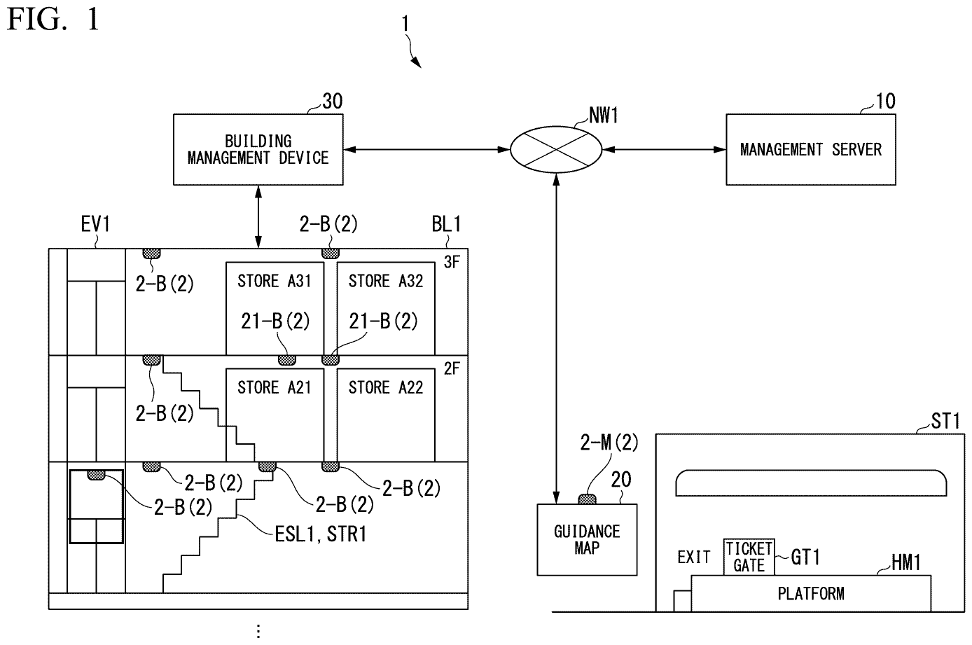

FIG. 1 is a configuration diagram showing an example of a guidance system 1 according to a first embodiment.

As shown in FIG. 1, the guidance system 1 includes a plurality of imaging devices 2 (2-B and 2-M), a management server 10, a guidance map 20, and a building management device 30.

The guidance system 1 provides guidance information tailored to the user within a range of a guidance target (for example, a building BL1) of the guidance map 20 in a guidance map 20 installed at a ticket gate GT1 of a station ST1.

In the example shown in FIG. 1, the guidance map 20 is installed at an exit beyond the ticket gate GT1 after leaving a platform HM1 of the station ST1. In addition, a plurality of stores (a store A21, a store A22, a store A31, and a store A32) are present in the building BL1 that is the guidance target of the guidance map 20.

In addition, an imaging device 2-M that can image the user near the guidance map 20 is installed in the guidance map 20. The guidance system 1 specifies the user based on an image captured by the imaging device 2-M, and outputs, as the guidance information, information on a store with a higher interest of the specified user among the plurality of stores (the store A21, the store A22, the store A31, and the store A32) in the building BL1.

The building management device 30 is a device that manages the building BL1, and collects interest information of the user who uses the building BL1. The building BL1 has an elevator EV1, an escalator ESL1, and stairs STR1 as means for moving between floors. In addition, the building BL1 has a plurality of imaging devices 2-B installed at a ceiling of each floor, a ceiling inside the elevator EV1, and the like.

The building management device 30 detects the movement of the user between the floors and a target of interest of the user, such as a store that the user visits on each floor, based on the images captured by the plurality of imaging devices 2-B, and collects the interest information of the user in the building BL1. That is, the building management device 30 collects the interest information representing a degree of interest of the user in the store or the like based on a past use history of the user in the building BL1.

The management server 10 is a server device that manages the guidance system 1. The management server 10 manages the user and the guidance map 20. The management server 10 may be, for example, a cloud server using cloud technology.

The management server 10, the guidance map 20, and the building management device 30 are connected to each other via a network NW1, and can communicate with each other via the network NW1. In the communication of the network NW1, various types of information are protected as needed.

In addition, in the present embodiment, the imaging device disposed in the building BL1 will be referred to as the imaging device 2-B, the imaging device disposed around the guidance map 20 will be referred to as an imaging device 2-M, and the imaging device will be referred to as an imaging device 2 in a case where any imaging device provided in the guidance system 1 is referred to or the imaging devices are not particularly distinguished.

In addition, in FIG. 1, for convenience of description, an example is described in which the guidance system 1 includes one guidance map 20, one building BL1, and one building management device 30, but a plurality of guidance maps 20, a plurality of buildings BL1, and a plurality of building management devices 30 may be provided.

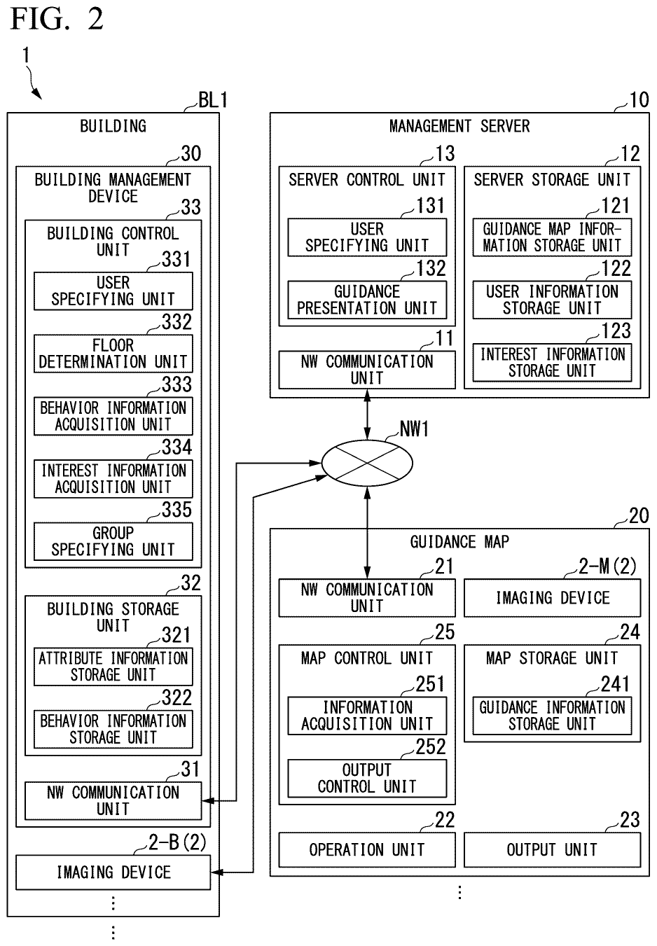

Next, details of each configuration of the guidance system 1 according to the present embodiment will be described with reference to FIG. 2.

FIG. 2 is a functional block diagram showing an example of the guidance system 1 according to the present embodiment.

As shown in FIG. 2, the guidance system 1 includes the imaging device 2-B, the management server 10, the guidance map 20, and the building management device 30.

As in FIG. 1, the description is made with a configuration in which the plurality of guidance maps 20, the plurality of buildings BL1, the plurality of building management devices 30, and the plurality of imaging devices 2-B are provided.

The imaging device 2-B (an example of a second imaging device) is, for example, a camera including a charge coupled device (CCD) image sensor. As shown in FIG. 1, the plurality of imaging devices 2-B are disposed in the building BL1. The imaging device 2-B captures, for example, an image including the user and transmits the captured image to the building management device 30 via the network NW1. The image captured by the imaging device 2-B may be a still image or a moving image, and the image captured by the imaging device 2-B is used for specifying the user or the like.

The building management device 30 is, for example, a device that manages a building such as a building including a store, and includes a network (NW) communication unit 31, a building storage unit 32, and a building control unit 33.

The NW communication unit 31 is a functional unit that is implemented, for example, by a communication device such as a network adapter. The NW communication unit 31 is connected to the network NW1 and performs, for example, data communication with the management server 10 and the imaging device 2-B.

The building storage unit 32 stores various types of information used by the building management device 30. The building storage unit 32 includes an attribute information storage unit 321 and a behavior information storage unit 322.

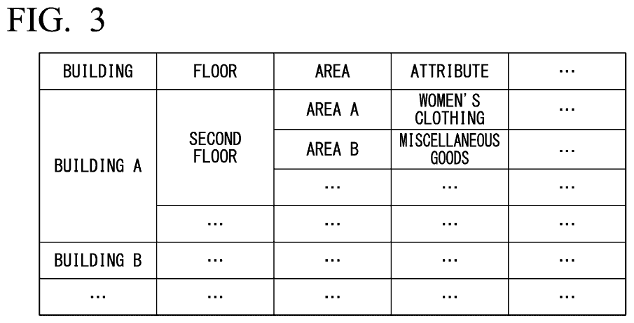

The attribute information storage unit 321 stores an attribute for each area for each floor of the building BL1. The area of each floor is a portion that occupies part or entirety of the floor. In addition, the area of each floor is, for example, a portion in which a tenant of the floor, a store in operation, and the like are located. Here, a data example of the attribute information storage unit 321 will be described with reference to FIG. 3.

FIG. 3 is a diagram showing the data example of the attribute information storage unit 321 according to the present embodiment.

As shown in FIG. 3, the attribute information storage unit 321 stores the building, the floor, the area, and the attribute in association with each other.

In FIG. 3, the building is identification information of the building, such as a building name, and the floor is identification information of the floor in the building. In addition, the area is identification information of the area, such as an area name, and the attribute indicates attribute information (for example, an attribute of the store, the tenant, or the like) corresponding to the area.

For example, FIG. 3 shows an example in which the attribute of the area of an area “A” on the floor of “second floor” in the building of “building A” is “women's clothing”, and the attribute of the area of an area “B” is “miscellaneous goods”.

In addition, the attribute information storage unit 321 may store information for specifying the area, for example, as a range of coordinates in each floor. The area is not limited to a two-dimensional plane and may be, for example, a high-dimensional space, such as a three-dimensional space. In addition, the attribute of the area represents one or more things, events, and the like. The attribute of the area may be, for example, the type of store, the type of item or service handled at the store, or the like in a case where the area is a store.

In addition, the attribute of the area may be, for example, a name of the store, a name of the item or service handled at the store, or the like in a case where the area is the store. Each area may have a plurality of attributes. One or more attributes of each area may be assigned by a person or may be assigned using artificial intelligence (AI).

Returning to the description of FIG. 2, the behavior information storage unit 322 stores behavior information acquired by a behavior information acquisition unit 333, which will be described later, for each user. The behavior information storage unit 322 stores, for example, identification information unique to the user and the behavior information of the user in association with each other.

The building control unit 33 is a functional unit that is implemented, for example, by causing a processor including a central processing unit (CPU), a system on chip (SoC), an application specific integrated circuit (ASIC), a graphics processing unit (GPU), a tensor processing unit (TPU), and the like to execute a program stored in a storage unit (not shown). The building control unit 33 integrally controls the building management device 30 to execute various processes in the building management device 30. The building control unit 33 includes a user specifying unit 331, a floor determination unit 332, the behavior information acquisition unit 333, an interest information acquisition unit 334, and a group specifying unit 335.

The user specifying unit 331 (an example of a second user specifying unit) specifies the user of the building BL1 based on at least the image captured by the imaging device 2-B. The user specifying unit 331 specifies the user by, for example, collating facial information of the user extracted from the image with the existing information by two-dimensional face authentication in a case where the existing information is present, and confirms the specification of the user.

The user specifying unit 331 may specify the user based on a learning result obtained by machine learning using training data in which the user specified in advance and the image in which the user is imaged are associated with each other. In this case, the user specifying unit 331 specifies the user based on the learning result and a feature value extracted from the image.

In addition, in a case where there is no existing information such as a first-time user, the user specifying unit 331 may newly register the facial information of the user extracted from the image. Here, as the facial information, for example, features such as a nose, ears, eyes, a mouth, cheeks, a chin, and a neck of a face, an entire contour treating each of these as an element, and the like are used. Further, as the facial information, features such as the shapes of the individual upper-body bones treating each of these as an element (for example, a skull shape or a bone ridge), and the like may also be used. In addition, in order to prevent the misuse of the facial information, the user specifying unit 331 may acquire information on, for example, an iris or a pupil of the eye. In a case where the pupil of the eye is not a circle or an ellipse but has unevenness, the user specifying unit 331 may detect a risk of acquiring false facial information created by AI or the like and issue an alert or the like.

In addition, the user specifying unit 331 transmits user information, such as the facial information of the specified user, to the management server 10 via the NW communication unit 31, and stores the user information in a user information storage unit 122 which will be described later.

In addition, in a case where two users are erroneously specified as the same user, the user specifying unit 331 may specify the two users as users different from each other. For example, in a case of specifying the two users as users different from each other, the user specifying unit 331 may extract the difference between the feature values of the users from the acquired images to improve a degree of certainty of the specification of the users and to reconfirm the specification of the users different from each other.

In addition, the user specifying unit 331 may perform adjustment, for example, by narrowing down a range of the feature value for performing the determination as the same user in accordance with the extracted difference between the feature values. The user specifying unit 331 may improve the degree of certainty of the specification of the user based on the difference between the feature values extracted by another method.

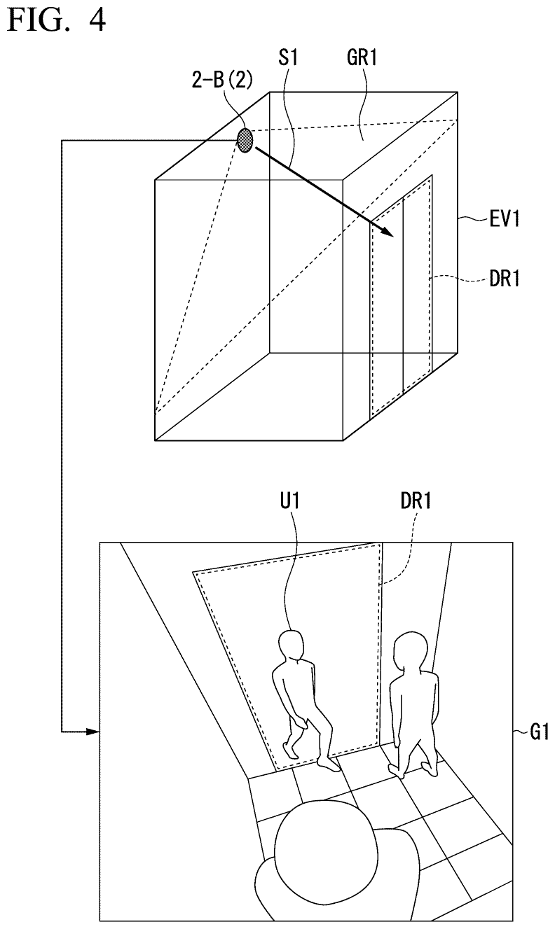

Next, a disposition example of the imaging device 2-B and a user specifying process by the user specifying unit 331 will be described with reference to FIGS. 4 to 6.

FIG. 4 is a diagram showing the disposition example of the imaging device 2-B in the elevator EV1 according to the present embodiment.

As shown in FIG. 4, the imaging device 2-B is attached to, for example, an upper portion of a wall or a ceiling inside the elevator EV1. The imaging device 2-B is disposed, for example, at a position at which a face of a user U1 who rides in the elevator EV1 can be imaged. In FIG. 4, the imaging device 2-B can image an imaging range GR1 and captures an image, such as a captured image G1. The user specifying unit 331 specifies the user U1 in a detection range DR1 based on the captured image G1. That is, the user specifying unit 331 executes a specifying process S1 of the user U1 who rides and exits the elevator EV1.

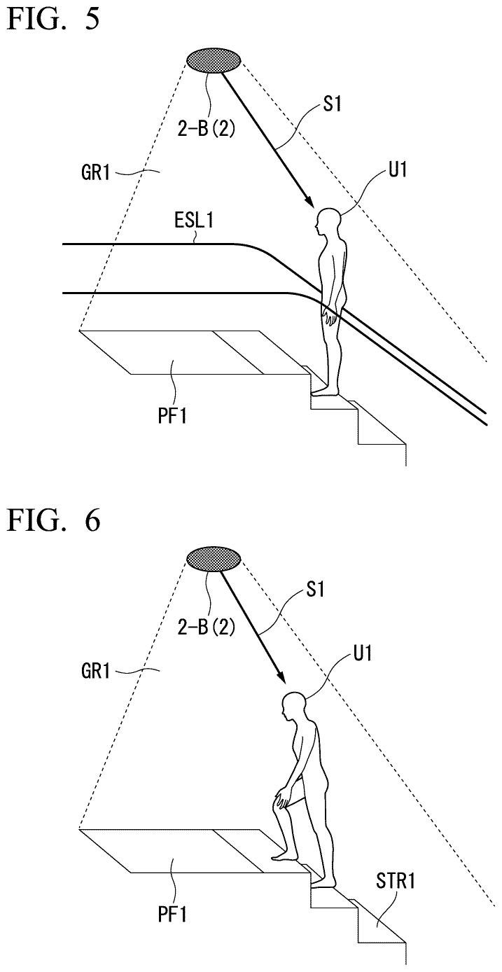

In addition, FIG. 5 is a diagram showing a disposition example of the imaging device 2-B in the escalator ESL1 according to the present embodiment. As shown in FIG. 5, the imaging device 2-B is disposed at an entrance/exit area PF1 of the escalator ESL1. Alternatively, the imaging device 2-B may be disposed on a wall surface of an inclined portion in front of the entrance/exit area PF1 of the escalator ESL1. In this case, the imaging device 2-B can image the imaging range GR1 near the entrance/exit area PF1 of the escalator ESL1. The user specifying unit 331 executes the specifying process S1 of the user U1 near the entrance/exit area PF1 of the escalator ESL1 based on the captured image obtained by imaging the imaging range GR1.

In addition, FIG. 6 is a diagram showing a disposition example of the imaging device 2-B on the stairs STR1 according to the present embodiment.

As shown in FIG. 6, the imaging device 2-B is disposed at the entrance/exit area PF1 of the stairs STR1. Alternatively, the imaging device 2-B may be disposed on a wall surface of an inclined portion in front of the entrance/exit area PF1 of the stairs STR1. In this case, the imaging device 2-B can image the imaging range GR1 near the entrance/exit area PF1 of the stairs STR1. The user specifying unit 331 executes the specifying process S1 of the user U1 near the entrance/exit area PF1 of the stairs STR1 based on the captured image obtained by imaging the imaging range GR1.

Returning to the description of FIG. 2 again, the floor determination unit 332 determines an arrival floor of the user, for the user specified by the user specifying unit 331. Here, the arrival floor of the user is a floor on which the user who uses the ascending/descending facility (for example, the elevator EV1, the escalator ESL1, or the stairs STR1) has completed the use of the ascending/descending facility. For example, in a case where the user uses the elevator EV1, the floor determination unit 332 determines a floor on which the user exits the elevator EV1 as the arrival floor of the user. The floor determination unit 332 determines the arrival floor based on the image captured by the imaging device 2-B. For example, in a case where the user has completed the use of the ascending/descending facility on any floor, the floor determination unit 332 determines the floor as the arrival floor of the user.

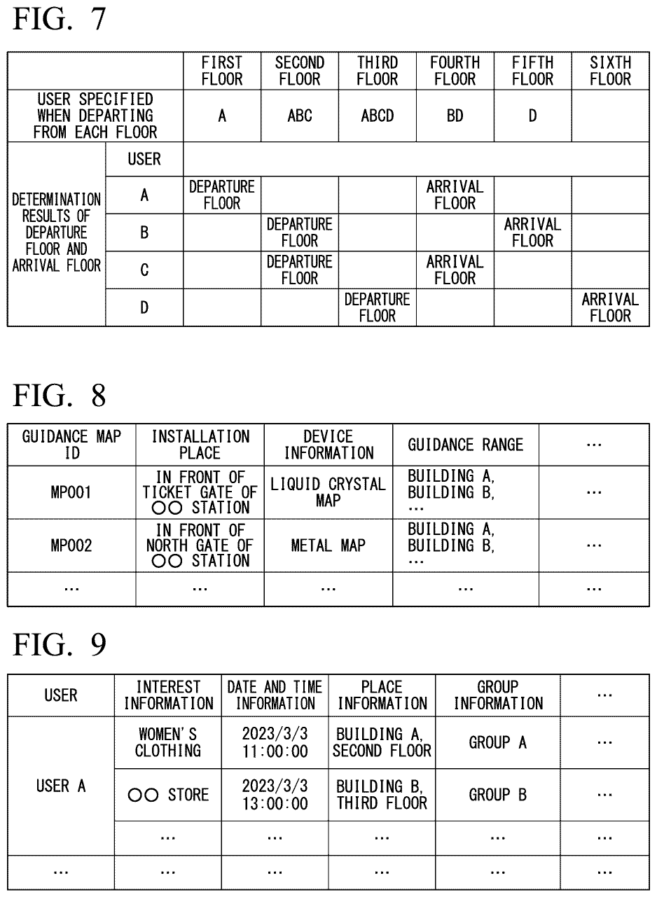

Here, a determination example of the arrival floor by the floor determination unit 332 will be described with reference to FIG. 7.

FIG. 7 is a diagram showing the determination example of the floor determination unit 332 according to the present embodiment.

FIG. 7 shows an example of determining the arrival floor of the user who uses the elevator EV1 that performs an ascending operation from a first floor. In this example, the elevator EV1 performs a descending operation to the first floor and then starts the ascending operation from the first floor. The floor determination unit 332 similarly determines the arrival floor even in cases of the ascending operation and the descending operation from another floor.

In the example shown in FIG. 7, for example, in a case where a user A moves from the first floor to a fourth floor using the elevator EV1, the user specifying unit 331 specifies the user A in a case where the user A rides the elevator EV1 on the first floor. In this case, the floor determination unit 332 determines that a departure floor of the user A is the first floor. In addition, in a case where the user A exits the elevator EV1 on the fourth floor, the floor determination unit 332 determines that the arrival floor of the user A is the fourth floor.

As described above, the floor determination unit 332 determines the arrival floor of the user among the plurality of floors in the building BL1 based on the image captured by at least any of the plurality of imaging devices 2-B while the user is moving.

Returning to the description of FIG. 2 again, the behavior information acquisition unit 333 acquires the behavior information representing the behavior of the user on the arrival floor determined by the floor determination unit 332 based on the image captured by at least any of the plurality of imaging devices 2-B.

The behavior information acquisition unit 333 extracts the feature value of the user from, for example, the image used by the user specifying unit 331 to specify the user. The behavior information acquisition unit 333 may use the feature value extracted by the user specifying unit 331.

The feature value of the user includes, for example, information on a position of the feature points such as a nose, ears, eyes, a mouth, cheeks, a chin, and a neck of the face, the entire contour treating each of these as an element, and both shoulders. Further, as the feature value of the user, features such as the shapes of the individual upper-body bones treating each of these as an element (for example, the skull shape or the bone ridges), and the like may also be used. The behavior information acquisition unit 333 acquires the behavior information of the user based on the extracted feature value.

In this example, the behavior information acquisition unit 333 acquires information including interest direction information as information on the disposition of the user included in the behavior information of the user. Here, the behavior information acquisition unit 333 continuously acquires the behavior information of the user by tracking the user specified by the user specifying unit 331. The behavior information acquisition unit 333 may track the position of the specified user by using, for example, a method such as moving object tracking.

In addition, the behavior information acquisition unit 333 may continuously acquire, by tracking the user, the behavior information of the user that is no longer shown in the image due to the movement. In addition, the interest direction information is an example of information representing a direction of interest of the user. The interest direction information is information represented by using three feature values of at least both shoulders and the nose of the user. In addition, the interest direction information may be represented by other feature values. Further, the interest direction information may be represented by using a feature value in accordance with AI.

In addition, in the interest direction information, an orientation of the interest direction of the user is represented as a direction from a midpoint of a line segment connecting the positions of both shoulders to the position of the nose. Here, regarding the nose of the user as the feature value used for the interest direction information, the feature value of the nose need only be captured regardless of whether or not the nose is covered with a mask or the like, that is, whether or not a naked nose of the user is shown in the image.

In addition, regarding the shoulder of the user as the feature value used for the interest direction information, the feature value of the shoulder need only be captured regardless of whether or not the shoulder is covered with clothing or the like, that is, whether or not a naked shoulder of the user is shown in the image. Similarly, regarding the other feature values for the organs such as the ears, the eyes, the mouth, the cheek, the chin, and the neck, or the entire contour treating each of these as an element, the feature value of the organ need only be captured regardless of whether or not a naked organ of the user is shown in the image. In addition, the interest direction information may be represented by, for example, feature values such as the shapes of the individual upper-body bones treating each of these as an element (for example, the skull shape or bone ridges), feature values of both shoulders and the nose obtained using skeleton information of the user, and the like. In addition, the interest direction information may be represented by using another feature value obtained by using the skeleton information.

Further, the behavior information acquisition unit 333 stores the acquired behavior information of the user in the behavior information storage unit 322 for each user.

The interest information acquisition unit 334 acquires the interest information representing the degree of interest of the user for each attribute based on the disposition and the attribute of the area on the arrival floor determined by the floor determination unit 332 and the behavior information acquired by the behavior information acquisition unit 333. The interest information acquisition unit 334 acquires the interest information for the user specified by the user specifying unit 331.

The interest information of the user is, for example, information representing a degree of interest of the user for each attribute assigned to the area. The interest information acquisition unit 334 acquires the interest information based on the behavior of the user on the arrival floor. Here, the behavior of the user includes, for example, information such as a stay time of the user on the arrival floor and the interest direction that is a direction of interest of the user on the arrival floor.

For example, the interest information acquisition unit 334 acquires the interest information based on the behavior of the user analyzed according to the information stored in the attribute information storage unit 321, the behavior information acquired by the behavior information acquisition unit 333, or the behavior information stored in the behavior information storage unit 322. One interest information represents the presence or absence of interest, and one interest information represents how high the degree of interest is. Either or both of a period in which the interest in the attribute assigned to the area in the interest direction of the user is shown and the stay time as elements are used to analyze how high the degree of interest is. The interest information acquisition unit 334 adds information each time information is added to each user from each floor.

In addition, the interest information acquisition unit 334 sorts the degree of interest, which is a result of analysis based on the updated information, in order of priority each time. The interest information acquisition unit 334 stores the acquired interest information in an interest information storage unit 123, which will be described later, for each user. The interest information acquisition unit 334 transmits the interest information to the management server 10 via the network NW1, and stores the acquired interest information in the interest information storage unit 123, which will be described later, for each user.

The group specifying unit 335 specifies a group acting in the building BL1. The group includes a plurality of users specified by the user specifying unit 331. The group specifying unit 335 registers the group, for example, as follows.

The group specifying unit 335 registers the plurality of users who stay in any area in the building BL1 for a time longer than a preset time threshold value as a group that spends time in the area. Here, the area in which the group spends time in the building BL1 is an area on the arrival floor determined by the floor determination unit 332 for the user included as a member in the group. In a case where the building BL1 includes a restaurant or the like, the area in which the group spends time in the building BL1 is the inside of the restaurant, or each room, each table, each seat, or the like in the restaurant. Here, the time threshold value may be set in common regardless of the area or may be set for each area.

The group specifying unit 335 specifies the user who stays in the area, for example, in a case where the behavior information acquisition unit 333 detects the entrance and exit of the user to and from any area based on the behavior information acquired by the behavior information acquisition unit 333. In a case where there are the plurality of users who stay in the area, the group specifying unit 335 calculates a time during which the plurality of users stay in the area together. The group specifying unit 335 registers the plurality of users as the group in a case where the time of staying together exceeds the time threshold value of the area.

In addition, in a case of newly specifying the group, the group specifying unit 335 assigns unique identification information to the group. Here, the group specifying unit 335 may register a gathering frequency for each group. For example, in a case where the group of which the time of staying together exceeds the time threshold value is already registered, the group specifying unit 335 increases the gathering frequency of the group.

In addition, the group specifying unit 335 specifies a group that starts using the ascending/descending facility provided in the building BL1, for example, as follows. The group specifying unit 335 specifies the group, for example, in a case where the plurality of users who start to use the same ascending/descending facility are detected based on the behavior information acquired by the behavior information acquisition unit 333.

The group specifying unit 335 transmits information on the specified group to the management server 10 via the network NW1, and stores the information in the interest information storage unit 123.

The management server 10 is a server device that manages the entire guidance system 1, and includes an NW communication unit 11, a server storage unit 12, and a server control unit 13.

The NW communication unit 11 is a functional unit that is implemented, for example, by a communication device such as a network adapter. The NW communication unit 11 is connected to the network NW1 and performs, for example, data communication with the building management device 30 and the guidance map 20.

The server storage unit 12 stores various types of information used by the management server 10. The server storage unit 12 includes a guidance map information storage unit 121, the user information storage unit 122, and the interest information storage unit 123.

The guidance map information storage unit 121 stores information related to the guidance map 20 which will be described later. The guidance map information storage unit 121 stores the information on the guidance map 20 registered in the guidance system 1. Here, a data example of the guidance map information storage unit 121 will be described with reference to FIG. 8.

FIG. 8 is a diagram showing the data example of the guidance map information storage unit 121 according to the present embodiment.

As shown in FIG. 8, the guidance map information storage unit 121 stores, for example, a guidance map ID, an installation place, device information, and a guidance range in association with each other.

In FIG. 8, the guidance map ID is guidance map identification information for identifying the guidance map 20. In addition, the installation place indicates a place at which the guidance map 20 is installed, and the device information indicates information indicating the type of device of the guidance map 20. In addition, the guidance range indicates a guidance range of the guidance target in the guidance map 20.

For example, FIG. 8 shows an example in which the guidance map 20 of which the guidance map ID is “MP001” is installed at the installation place of “in front of the ticket gate of OO station” and has the device information of “liquid crystal map” (liquid crystal display board). In addition, the guidance range of the guidance map 20 indicates a range of “building A, building B, . . . ”.

Returning to the description of FIG. 2, the user information storage unit 122 stores information related to the user specified by the user specifying unit 331. The user information storage unit 122 stores, for example, identification information of the user and information (for example, the feature value and the like) for specifying the user in association with each other.

The interest information storage unit 123 stores the interest information representing the degree of interest of the user. The interest information storage unit 123 stores, for example, the interest information for each user. Here, a data example of the interest information storage unit 123 will be described with reference to FIG. 9.

FIG. 9 is a diagram showing the data example of the interest information storage unit 123 according to the present embodiment.

As shown in FIG. 9, the interest information storage unit 123 stores, for example, the user, the interest information, date and time information, place information, and group information in association with each other.

In FIG. 9, the user identification information such as a user name and a user ID is shown for the user, and the interest information acquired by the interest information acquisition unit 334 described above is shown for the interest information. In addition, the date and time information and the place information in a case where the interest information acquisition unit 334 acquires the interest information are shown for the date and time information and the place information. In addition, the identification information of the group to which the user belongs, which is registered by the group specified by the group specifying unit 335 described above, is shown for the group information.

For example, FIG. 9 shows an example in which the interest information of the user corresponding to “user A” is “women's clothing”, and the interest information is acquired at “building A, second floor” on “2023 Mar. 3” (Mar. 3, 2023). Further, in the interest information, “user A” belongs to “group A”.

Returning to the description of FIG. 2 again, the server control unit 13 is a functional unit that is implemented, for example, by causing a processor including a CPU and the like to execute a program stored in a storage unit (not shown). The server control unit 13 integrally controls the management server 10 to execute various processes in the management server 10.

The server control unit 13 includes a user specifying unit 131 and a guidance presentation unit 132.

The user specifying unit 131 (an example of a first user specifying unit) specifies the user based on the image captured by the imaging device 2-M that can capture the image of the user near the guidance map 20. The user specifying unit 131 specifies the user by using the same method as in the user specifying unit 331 described above based on the image acquired from the guidance map 20, which is the image captured by the imaging device 2-M, via the NW communication unit 11.

The user specifying unit 131 specifies the user based on, for example, a learning result obtained by machine learning using training data in which the user specified in advance and the image in which the user is imaged are associated with each other. The user specifying unit 131 specifies the user based on the learning result and a feature value extracted from the image. Specifically, the user specifying unit 131 specifies the user near the guidance map 20 based on, for example, the image captured by the imaging device 2-M and the information stored in the user information storage unit 122.

The guidance presentation unit 132 causes the guidance map 20 to output the guidance information about the area within a range of the guidance target based on the interest information that is acquired from the interest information storage unit 123 described above and that corresponds to the user specified by the user specifying unit 131 and the attribute of the area within the range of the guidance target, which is acquired from the attribute information storage unit 321.

The guidance presentation unit 132 acquires the interest information corresponding to the user from the interest information storage unit 123. In addition, the guidance presentation unit 132 checks the guidance range of the guidance map 20 by the guidance map information storage unit 121, and acquires the attribute information of the area within the range of the guidance target from the attribute information storage unit 321 of the guidance target (for example, the building BL1) within the guidance range via the NW communication unit 11. The guidance presentation unit 132 causes the guidance map 20 to output the guidance information about the area having the attribute with a higher degree of interest of the specified user, based on the acquired interest information corresponding to the user and the attribute information of the area within the range of the guidance target.

The guidance presentation unit 132 transmits the guidance information to the guidance map 20 via the NW communication unit 11 and the network NW1, and causes an output unit 23 of the guidance map 20 to output the guidance information.

In a case where the user specifying unit 131 specifies the plurality of users, the guidance presentation unit 132 may cause the guidance map 20 to output, for example, the guidance information corresponding to the user at a position closest to the guidance map 20, or may cause the guidance map 20 to output the guidance information obtained by performing a logical OR (OR) or a logical AND (AND) on the interest information of the plurality of users.

In addition, in a case where the user specifying unit 131 specifies the plurality of users, and the group including the specified users is confirmed, the guidance presentation unit 132 may cause the guidance map 20 to output the guidance information about the area within the range of the guidance target having the attribute with a higher degree of interest of the group. In this case, in a case where at least a preset number of the users belonging to the group are specified, the guidance presentation unit 132 may cause the guidance map 20 to output the guidance information about the area within the range of the guidance target having the attribute with a higher degree of interest of the group.

In addition, in a case where at least a preset proportion of the users belonging to the group are specified, the guidance presentation unit 132 may cause the guidance map 20 to output the guidance information about the area within the range of the guidance target having the attribute with a higher degree of interest of the group.

The guidance map 20 is, for example, a guidance device installed at the station ST1, a bus stop, or the like, and the guidance target (for example, the building A or the like) and the guidance range are determined in advance. The guidance map 20 includes the imaging device 2-M, the NW communication unit 21, an operation unit 22, the output unit 23, a map storage unit 24, and a map control unit 25.

The imaging device 2-M (an example of a first imaging device) is, for example, a camera including a CCD image sensor. The imaging device 2-M is disposed to be able to image the user near the guidance map 20. The imaging device 2-M captures, for example, an image including the user who has come to see the guidance map 20, and transmits the captured image to the management server 10 via the NW communication unit 21. The image captured by the imaging device 2-M may be a still image or a moving image, and the image captured by the imaging device 2-M is used for specifying the user or the like.

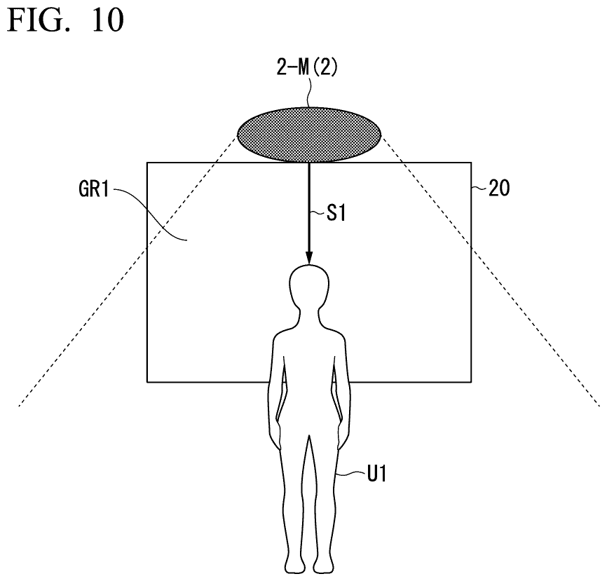

Here, a disposition example of the imaging device 2-M in the guidance map 20 will be described with reference to FIG. 10. FIG. 10 is a diagram showing the disposition example of the imaging device 2-M in the guidance map 20 according to the present embodiment.

As shown in FIG. 10, the imaging device 2-M is attached to, for example, an upper portion of the guidance map 20. The imaging device 2-M is disposed at a position at which the face of the user U1 who uses the guidance map 20 can be imaged. In FIG. 10, the imaging device 2-M can image the imaging range GR1, and executes the specifying process S1 of the user U1 who uses the guidance map 20 based on the captured image captured by the imaging device 2-M.

Returning to the description of FIG. 2 again, the NW communication unit 21 is a functional unit that is implemented, for example, by a communication device such as a network adapter. The NW communication unit 21 is connected to the network NW1 and performs, for example, data communication with the management server 10.

The operation unit 22 is, for example, a switch, a button, a touch sensor, or the like installed in the guidance map 20, and receives operation information (input information) of the user.

The output unit 23 is, for example, a display device such as a liquid crystal display, or a sound output device such as a speaker. The output unit 23 outputs the guidance information.

The output unit 23 displays the guidance information in a case where the output unit 23 is a display device, and outputs a voice indicating the guidance information in a case where the output unit 23 is a sound output device. The output unit 23 may be a light emitting diode that makes the position of the guidance target installed on a map board of a predetermined guidance range visible by light emission, or the like. In this case, the output unit 23 performs output for notifying of the position on the map board as the guidance information by causing the light emitting diode to emit light.

The map storage unit 24 stores various types of information used by the guidance map 20. The map storage unit 24 includes a guidance information storage unit 241.

The guidance information storage unit 241 stores the guidance information acquired from the guidance presentation unit 132, and the like.

The map control unit 25 is a functional unit that is implemented, for example, by causing a processor including a CPU and the like to execute a program stored in a storage unit (not shown). The map control unit 25 integrally controls the guidance map 20 to execute various processes in the guidance map 20. The map control unit 25 includes an information acquisition unit 251 and an output control unit 252.

The information acquisition unit 251 acquires various types of information related to the guidance map 20. The information acquisition unit 251 acquires the captured image from the imaging device 2-M, and transmits the captured image to the management server 10 via the NW communication unit 21. In addition, the information acquisition unit 251 acquires, for example, the guidance information from the management server 10 via the NW communication unit 21, stores the guidance information in the guidance information storage unit 241, and causes the output control unit 252 to output the guidance information.

In addition, the information acquisition unit 251 acquires the operation information of the user from the operation unit 22, and uses the operation information for various processes of the guidance map 20. For example, in a case where the operation information of the user is acquired during the output of the guidance information, the information acquisition unit 251 may cause the output control unit 252 to output, for example, more detailed guidance information in accordance with the operation information of the user.

The output control unit 252 controls the output unit 23. For example, the output control unit 252 acquires the guidance information from the guidance information storage unit 241 and causes the guidance information to be output from the output unit 23.

Next, an operation of the guidance system 1 according to the present embodiment will be described with reference to the drawings.

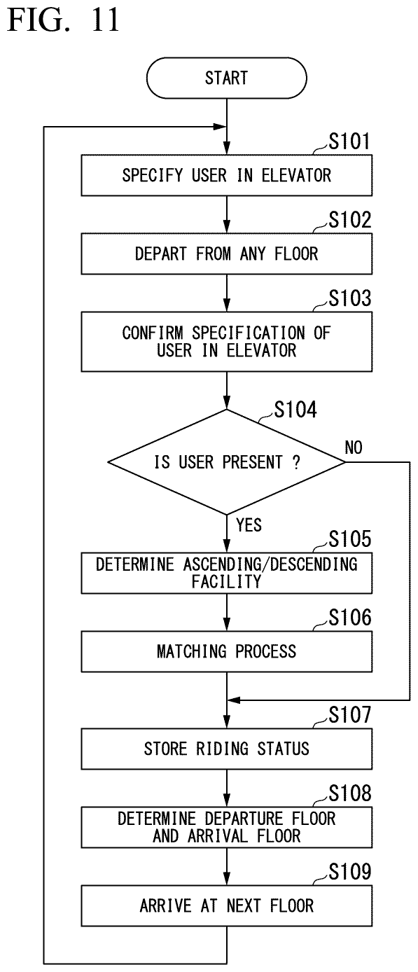

FIG. 11 is a flowchart showing an example of an arrival floor determination process of the guidance system 1 according to the present embodiment in a case where the elevator EV1 is used.

As shown in FIG. 11, the user specifying unit 331 of the building management device 30 first specifies the user in the elevator EV1 (step S101). The user specifying unit 331 specifies the user who enters the elevator EV1 based on the captured image captured by the imaging device 2-B in a case where a door of the elevator EV1 is open.

Next, when the elevator EV1 departs from any floor (step S102), the floor determination unit 332 starts a floor determination process. Here, a case where the elevator EV1 departs from any floor corresponds to, for example, a case where the door of the elevator EV1 is completely closed on the floor.

Next, the user specifying unit 331 confirms the specification of the user riding in the elevator EV1 (step S103).

Next, the user specifying unit 331 determines whether or not there is the user riding in the elevator EV1 (step S104). When there is the user riding in the elevator EV1 (step S104: YES), the user specifying unit 331 advances the process to step S105. In addition, when there is no user riding in the elevator EV1 (NO in step S104), the user specifying unit 331 advances the process to step S107.

In step S105, the user specifying unit 331 determines that the used ascending/descending facility is the elevator EV1 for the user specified in the elevator EV1.

Next, the user specifying unit 331 performs a matching process for the specified user (step S106). The user specifying unit 331 performs an exclusion process of the user, and the user specifying unit 331 specifies the plurality of users as users different from each other. For example, in a case of specifying the two users as users different from each other, the user specifying unit 331 extracts the difference between the feature values of the users from the acquired images to improve the degree of certainty of the specification of the users and to reconfirm the specification of the users different from each other.

Next, in step S107, the floor determination unit 332 stores a usage status of the elevator EV1 based on a result of the specification by the user specifying unit 331. The usage status of the elevator EV1 includes, for example, the presence or absence of the user riding the elevator EV1, and information for identifying the user in a case where the user rides the elevator EV1.

Next, the floor determination unit 332 determines the departure floor and the arrival floor of the user (step S108). The floor determination unit 332 determines the departure floor and the arrival floor of the user based on the usage status stored in step S107 and the usage status stored immediately before the usage status is stored in step S107.

Next, when the elevator EV1 arrives at the next floor (step S109), the floor determination unit 332 returns the process to step S101.

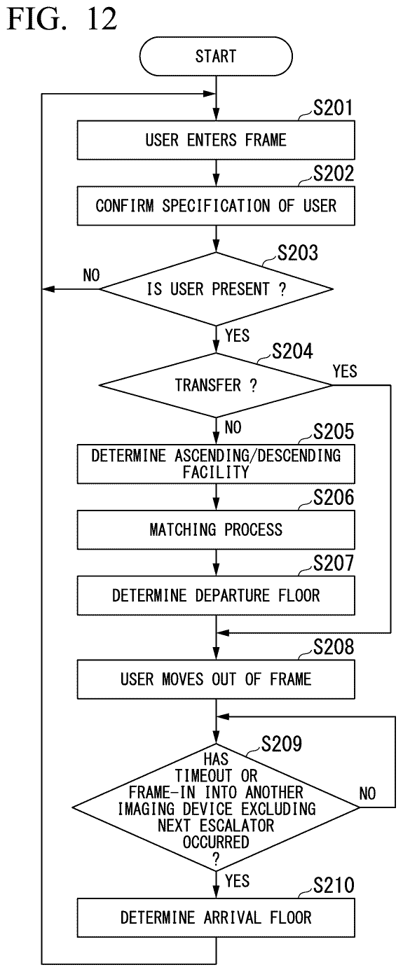

Next, the arrival floor determination process in a case where the escalator ESL1 is used will be described with reference to FIG. 12.

FIG. 12 is a flowchart showing an example of an arrival floor determination process of the guidance system 1 according to the present embodiment in a case where the escalator ESL1 is used.

As shown in FIG. 12, when the user has entered the frame of the imaging device 2-B provided at the exit of any escalator ESL1 (step S201), the building management device 30 starts the arrival floor determination process.

Next, the user specifying unit 331 specifies the user riding the escalator ESL1, and confirms the specification of the user (step S202).

Next, the user specifying unit 331 determines whether or not there is the user riding the escalator ESL1 (step S203). When there is the user riding the escalator ESL1 (YES in step S203), the user specifying unit 331 advances the process to step S204. In addition, when there is no user riding the escalator ESL1 (NO in step S203), the user specifying unit 331 returns the process to step S201.

In step S204, the floor determination unit 332 determines whether or not the specified user is the user who has transferred to the escalator ESL1. For example, in a case where a predetermined time has not elapsed after the user has moved out of the frame of the imaging device 2-B disposed at the exit of the other escalator ESL1, the floor determination unit 332 determines that the user is the user who has transferred to the escalator ESL1. When the specified user is the user who has transferred to the escalator ESL1 (YES in step S204), the floor determination unit 332 advances the process to step S208. In addition, when the specified user is not the user who has transferred to the escalator ESL1 (NO in step S204), the floor determination unit 332 advances the process to step S205.

In step S205, the user specifying unit 331 determines that the used ascending/descending facility is the escalator ESL1 for the user specified in the escalator ESL1.

Next, the user specifying unit 331 performs the matching process for the specified user (step S206).

Next, the floor determination unit 332 determines the floor on which an entrance of the escalator ESL1 is provided as the departure floor of the user (step S207).

Next, in step S208, when the user has moved out of the frame of the imaging device 2-B provided at the exit of the escalator ESL1, the floor determination unit 332 starts measuring a time from when the user has moved out of the frame.

Next, the floor determination unit 332 determines whether or not the timeout has occurred, that is, whether, after the user has moved out of the frame, no frame-in into the imaging device 2-B of the next escalator ESL1 has occurred and a predetermined period has elapsed (step S209). When the timeout has occurred (step S209: YES), the floor determination unit 332 advances the process to step S210. In addition, when the timeout has not occurred (step S209: NO), the floor determination unit 332 returns the process to step S209.

In step S210, the floor determination unit 332 determines the floor on which the exit of the escalator ESL1 is provided as the arrival floor of the user. After the process of step S210, the floor determination unit 332 returns the process to step S201.

In addition, since the arrival floor determination process of the guidance system 1 according to the present embodiment in a case where the stairs STR1 is used is the same as the arrival floor determination process in a case where the escalator ESL1 shown in FIG. 12 is used, the description thereof will be omitted here.

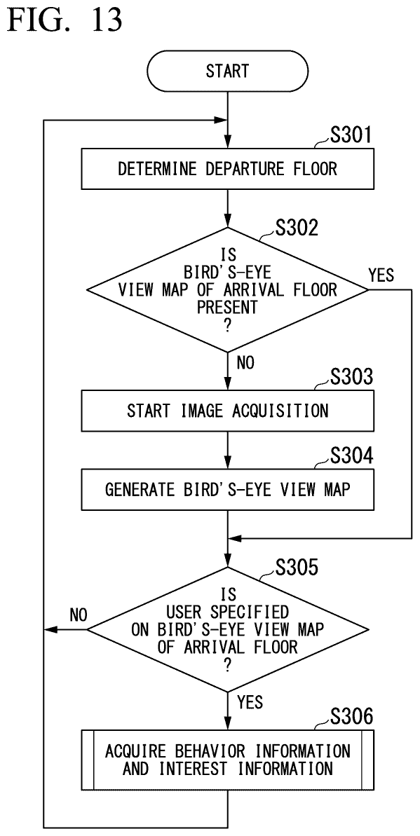

Next, a process of acquiring the behavior information and the interest information in the guidance system 1 according to the present embodiment will be described with reference to FIG. 13.

FIG. 13 is a flowchart showing an example of the process of acquiring the behavior information and the interest information in the guidance system 1 according to the present embodiment.

As shown in FIG. 13, when the floor determination unit 332 performs the arrival floor determination (step S301), the building management device 30 starts the process of acquiring the behavior information and the interest information.

Next, the user specifying unit 331 determines whether or not there is a bird's-eye view map of the arrival floor (step S302). When the bird's-eye view map of the arrival floor is present (step S302: YES), the user specifying unit 331 advances the process to step S305. In addition, when the bird's-eye view map of the arrival floor is not present (NO in step S302), the user specifying unit 331 advances the process to step S303.

In step S303, the behavior information acquisition unit 333 starts acquiring the image from the imaging device 2-B disposed on the arrival floor.

Next, the behavior information acquisition unit 333 generates the bird's-eye view map from the acquired image) (step S304).

Next, in step S305, the user specifying unit 331 determines whether or not the user who has arrived at the arrival floor can be specified on the bird's-eye view map. When the user who has arrived at the arrival floor can be specified on the bird's-eye view map (step S305: YES), the user specifying unit 331 advances the process to step S306. In addition, when the user who has arrived at the arrival floor cannot be specified on the bird's-eye view map (NO in step S305), the user specifying unit 331 returns the process to step S301.

In step S306, the building management device 30 acquires the behavior information and the interest information for the user specified in step S305. Here, when the plurality of users are specified in step S305, the building management device 30 may acquire the behavior information and the interest information in parallel for the plurality of users. After the process of step S306, the building management device 30 returns the process to step S301.

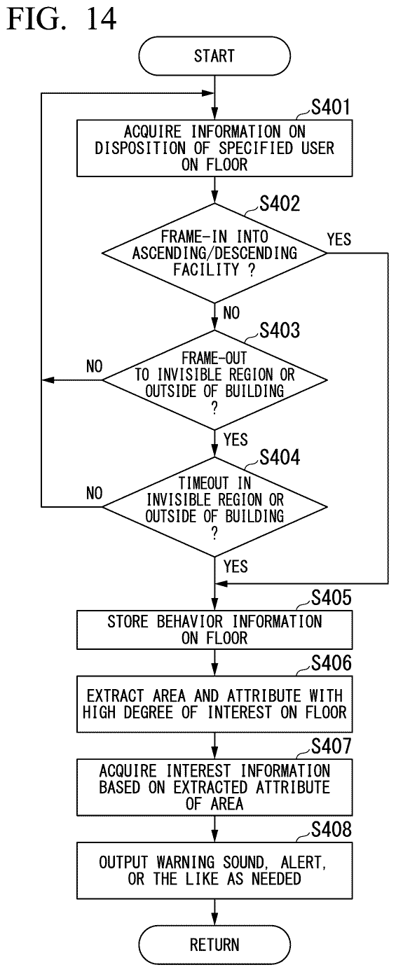

Next, details of the process of step S306 will be described with reference to FIG. 14.

FIG. 14 is a flowchart showing an example of a detailed process of step S306 in FIG. 13.

As shown in FIG. 14, the behavior information acquisition unit 333 acquires the information on the disposition of the specified user (step S401). In this example, the behavior information acquisition unit 333 acquires information on coordinates of at least three feature values of both shoulders and the nose of the user. The behavior information acquisition unit 333 may acquire information on coordinates of other feature values of the user.

Next, the behavior information acquisition unit 333 determines whether or not the user has entered the frame of the ascending/descending facility (step S402). The frame-in to the ascending/descending facility is the frame-out as viewed from the floor on which the user is present. When the user has entered the frame of the ascending/descending facility (step S402: YES), the behavior information acquisition unit 333 advances the process to step S405. In addition, when the user has not entered the frame of the ascending/descending facility (step S402: NO), the behavior information acquisition unit 333 advances the process to step S403.

In step S403, the behavior information acquisition unit 333 determines whether or not the user has moved out of the frame from an invisible region or an entrance/exit of the building BL1 to the outside. When the user has moved out of the frame from the invisible region or the entrance/exit of the building BL1 to the outside (step S403: YES), the behavior information acquisition unit 333 advances the process to step S404. In addition, when the user has not moved out of the frame from the invisible region or the entrance/exit of the building BL1 to the outside (NO in step S403), the behavior information acquisition unit 333 returns the process to step S401.

In step S404, the behavior information acquisition unit 333 determines whether or not the timeout has occurred, that is, whether or not a preset time has elapsed after the user has moved out of the frame from the invisible region or the entrance/exit of the building BL1 to the outside. When the timeout has occurred (step S404: YES), the behavior information acquisition unit 333 advances the process to step S405. In addition, when the timeout has not occurred (NO in step S404), the behavior information acquisition unit 333 returns the process to step S401.

In step S405, the behavior information acquisition unit 333 completes the acquisition of the behavior information, and stores the acquired behavior information in the behavior information storage unit 322. The behavior information acquisition unit 333 stores the acquired behavior information in the behavior information storage unit 322 as time-series data for each user.

Next, the interest information acquisition unit 334 extracts the area and the attribute with a high degree of interest of the user on the floor based on the behavior information of the user (step S406).

Next, the interest information acquisition unit 334 acquires the interest information based on the extracted attribute of the area (step S407). The interest information acquisition unit 334 refers to the attribute of the area with a high degree of interest of the user from the attribute information storage unit 321. The interest information acquisition unit 334 acquires the interest information based on the information on the degree of interest of the user and the information on the referred attribute, and stores the acquired interest information in the interest information storage unit 123. The interest information acquisition unit 334 transmits the interest information to the management server 10 via the NW communication unit 31, and stores the interest information in the interest information storage unit 123. The interest information acquisition unit 334 may update the interest information for each user by using the acquired interest information in the interest information storage unit 123.

Next, the building management device 30 outputs a warning sound, an alert, or the like as needed (step S408). The building management device 30 outputs the warning sound, the alert, or the like, for example, in a case where the frame-in and the frame-out of the user are not matched. A case where the frame-in and the frame-out of the user are not matched corresponds to, for example, a case where the frame-out of the user who has entered the frame is not determined, or a case where the frame-out of the user who has not entered the frame is determined. In addition, when the output of the warning sound, the alert, or the like is not needed, the process of step S408 may be omitted.

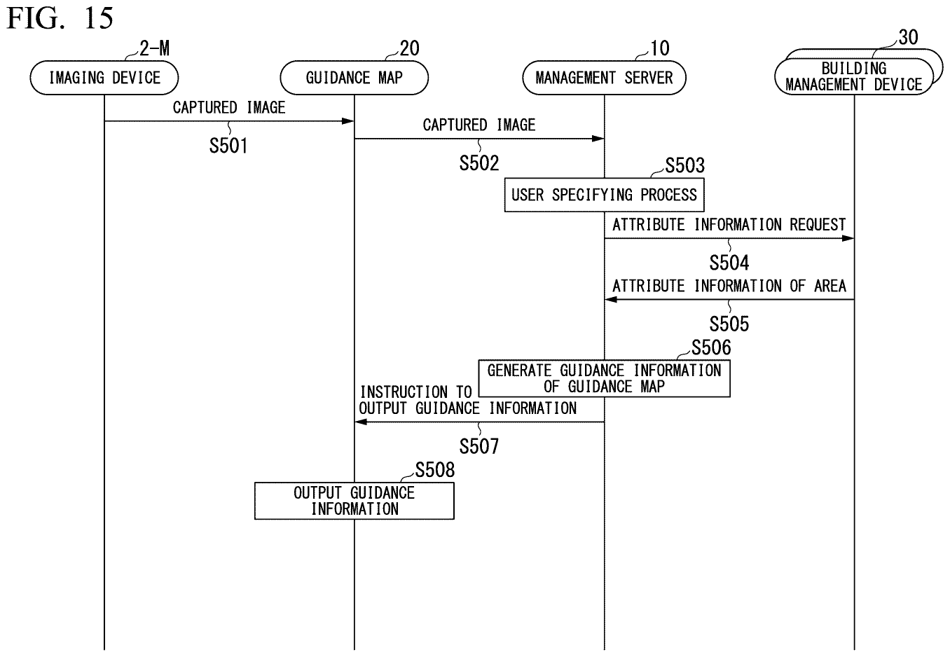

Next, a guidance process of the guidance system 1 according to the present embodiment will be described with reference to FIG. 15.

FIG. 15 is a diagram showing an example of the guidance process of the guidance system 1 according to the present embodiment.

As shown in FIG. 15, first, the imaging device 2-M transmits the captured image to the guidance map 20 (step S501), and the guidance map 20 transmits the captured image to the management server 10 (step S502). That is, the information acquisition unit 251 of the guidance map 20 acquires the captured image of the vicinity of the guidance map 20, which is captured by the imaging device 2-M, and transmits the captured image to the management server 10 via the NW communication unit 21.

Next, the user specifying unit 131 of the management server 10 executes the user specifying process (step S503). The user specifying unit 131 specifies the user based on the captured image of the vicinity of the guidance map 20, which is captured by the imaging device 2-M.

Then, the guidance presentation unit 132 of the management server 10 transmits an attribute information request to the building management device 30 within the range of the guidance target of the guidance map 20 (step S504), and the building management device 30 transmits the attribute information of the area stored in the attribute information storage unit 321 to the management server 10 (step S505).

Next, the guidance presentation unit 132 of the management server 10 generates the guidance information of the guidance map 20 based on the interest information stored in the interest information storage unit 123 and the attribute information of the area acquired from the building management device 30 within the range of the guidance target (step S506).

Next, the guidance presentation unit 132 of the management server 10 transmits the guidance information to the guidance map 20 (step S507).

Next, the guidance map 20 outputs the guidance information (step S508). The output control unit 252 of the guidance map 20 causes the guidance information that is generated by the guidance presentation unit 132 and that corresponds to the user specified by the user specifying unit 131 to be output from the output unit 23.

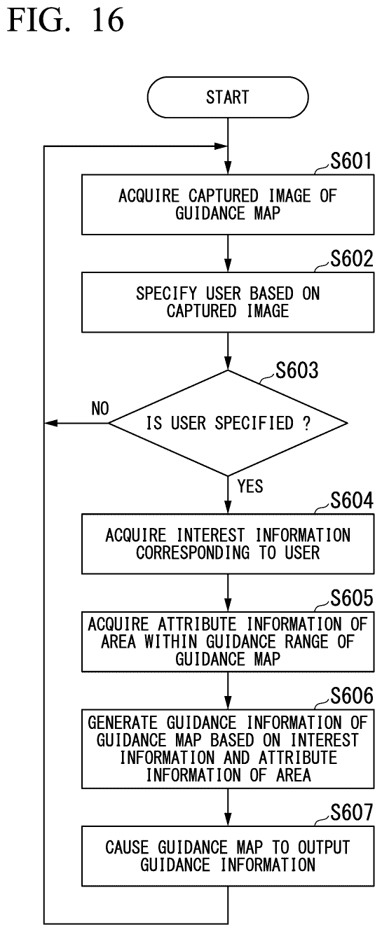

Next, details of the guidance process of the guidance system 1 according to the present embodiment will be described with reference to FIG. 16.

FIG. 16 is a flowchart showing details of the guidance process of the guidance system 1 according to the present embodiment. Here, details of the guidance process in the management server 10 will be described.

As shown in FIG. 16, the user specifying unit 131 of the management server 10 acquires the captured image of the guidance map 20 (step S601). The user specifying unit 131 acquires the captured image of the vicinity of the guidance map 20, which is captured by the imaging device 2-M, via the NW communication unit 11.

Next, the user specifying unit 131 specifies the user based on the acquired captured image (step S602). The user specifying unit 131 specifies the user who uses the guidance map 20 based on the captured image and the user information stored in the user information storage unit 122.

Next, the user specifying unit 131 determines whether or not the user can be specified (step S603). When the user who uses the guidance map 20 can be specified (step S603: YES), the user specifying unit 131 advances the process to step S604. In addition, when the user who uses the guidance map 20 cannot be specified (NO in step S603), the user specifying unit 131 returns the process to step S601.

In step S604, the guidance presentation unit 132 acquires the interest information corresponding to the user. The guidance presentation unit 132 acquires the interest information corresponding to the user specified by the user specifying unit 131 from the interest information storage unit 123.

Next, the guidance presentation unit 132 acquires the attribute information of the area within the guidance range of the guidance map 20 (step S605). The guidance presentation unit 132 refers to the guidance map information storage unit 121 and acquires the guidance range (for example, the building name of the guidance target and the like) of the guidance map 20. The guidance presentation unit 132 acquires the attribute information of the area from the building management device 30 of the building (for example, the building A, the building B, and the like) that is the guidance target. In a case where the guidance range of the guidance map 20 includes a plurality of buildings, the guidance presentation unit 132 acquires the attribute information of the area from the building management device 30 of each building among the plurality of buildings.

Next, the guidance presentation unit 132 generates the guidance information of the guidance map 20 based on the interest information and the attribute information of the area. The guidance presentation unit 132 extracts, for example, the area of the attribute that matches the interest information, and generates the guidance information of the area. That is, the guidance presentation unit 132 generates the guidance information about the area within the range of the guidance target having the attribute with a higher degree of interest of the specified user.

Next, the guidance presentation unit 132 causes the guidance map 20 to output the guidance information (step S607). The guidance presentation unit 132 transmits the generated guidance information to the guidance map 20 via the NW communication unit 11, and causes the output control unit 252 of the guidance map 20 to output the guidance information from the output unit 23. After the process of step S607, the guidance presentation unit 132 returns the process to step S601.

As described above, the guidance system 1 according to the present embodiment includes the imaging device 2-M, the user specifying unit 131, and the guidance presentation unit 132. The imaging device 2-M can image the user near the guidance map 20 that provides guidance about the guidance target. The user specifying unit 131 specifies the user based on the image captured by the imaging device 2-M. The guidance presentation unit 132 causes the guidance map 20 to output the guidance information about the area within the range of the guidance target having the attribute with a higher degree of interest of the specified user based on the interest information corresponding to the user specified by the user specifying unit 131 and the attribute of the area within the range of the guidance target, which is acquired from the attribute information storage unit 321. Here, the guidance presentation unit 132 acquires the interest information corresponding to the user from the interest information storage unit 123 that stores the interest information representing the degree of interest of the user.

Accordingly, in the guidance system 1 according to the present embodiment, the user of the guidance map 20 is specified based on the captured image of the vicinity of the guidance map 20, and the guidance map 20 outputs the guidance information having the attribute with a higher degree of interest of the user based on the interest information corresponding to the user and the attribute of the area within the range of the guidance target. Therefore, the guidance system 1 according to the present embodiment can provide appropriate guidance tailored to the user without requiring the means for acquiring the positional information, such as the GPS.

In addition, in the present embodiment, the user specifying unit 131 specifies the user based on the learning result obtained by machine learning using the training data in which the user specified in advance and the image in which the user is imaged are associated with each other.

Accordingly, the guidance system 1 according to the present embodiment can more accurately specify the user through the machine learning, and can provide more appropriate guidance tailored to the user.

In addition, in the present embodiment, the user specifying unit 131 specifies the user based on the learning result and the feature value extracted from the image.

Accordingly, the guidance system 1 according to the present embodiment can improve the accuracy of specifying the user.

In addition, in the present embodiment, in a case where the group including the specified user is confirmed, the guidance presentation unit 132 causes the guidance map 20 to output the guidance information about the area within the range of the guidance target having the attribute with a higher degree of interest of the group.

Accordingly, the guidance system 1 according to the present embodiment can provide appropriate guidance not only tailored to the user alone but also tailored to the group.

In addition, in the present embodiment, in a case where at least a preset number of the users belonging to the group are specified, the guidance presentation unit 132 causes the guidance map 20 to output the guidance information about the area within the range of the guidance target having the attribute with a higher degree of interest of the group.

Accordingly, the guidance system 1 according to the present embodiment can appropriately switch between the guidance for the user and the guidance for the group by a simple method.

In addition, in the present embodiment, in a case where at least a preset proportion of the users belonging to the group are specified, the guidance presentation unit 132 causes the guidance map 20 to output the guidance information about the area within the range of the guidance target having the attribute with a higher degree of interest of the group.

Accordingly, the guidance system 1 according to the present embodiment can appropriately switch between the guidance for the user and the guidance for the group by a simple method.

In addition, the guidance system 1 according to the present embodiment includes the guidance map 20 including the output unit 23 (for example, a display device, a speaker, or the like) that outputs the guidance information. The guidance presentation unit 132 causes the output unit 23 to output the guidance information.

Accordingly, the guidance system 1 according to the present embodiment can provide appropriate guidance tailored to the user by using the output unit 23 without requiring the means for acquiring the positional information.

In addition, the guidance system 1 according to the present embodiment includes the management server 10 (server device) that is connectable to the guidance map 20 via the network NW1. The management server 10 includes the interest information storage unit 123 and the guidance presentation unit 132. The guidance presentation unit 132 causes the output unit 23 of the guidance map 20 to output the guidance information via the network NW1.

Accordingly, in the guidance system 1 according to the present embodiment, the management server 10 executes a process of the guidance presentation unit 132, and the guidance map 20 outputs the guidance information received from the management server 10, so that it is possible to reduce the processing load of the guidance map 20. Therefore, the guidance system 1 according to the present embodiment can provide appropriate guidance tailored to the user even for the guidance map 20 having a simple configuration in which a light emitting diode installed at a position of a guidance place emits light on a guidance map board on which a map is drawn.

In addition, the guidance system 1 according to the present embodiment includes the imaging device 2-M (first imaging device), the plurality of imaging devices 2-B (a plurality of second imaging devices), the floor determination unit 332, the behavior information acquisition unit 333, and the interest information acquisition unit 334. The imaging device 2-M (first imaging device) can image the user near the guidance map 20. The plurality of imaging devices 2-B (a plurality of second imaging devices) are installed in the building within the range of the guidance target. The floor determination unit 332 determines the arrival floor of the user among the plurality of floors in the building based on the image captured by at least any of the plurality of imaging devices 2-B while the user is moving. The behavior information acquisition unit 333 acquires the behavior information representing the behavior of the user on the arrival floor determined by the floor determination unit 332 based on the image captured by at least any of the plurality of imaging devices 2-B. The interest information acquisition unit 334 acquires the interest information representing the degree of interest of the user for each attribute based on the disposition and the attribute of the area on the arrival floor determined by the floor determination unit 332 and the behavior information acquired by the behavior information acquisition unit, and stores the interest information in the interest information storage unit 123 for each user.

Accordingly, the guidance system 1 according to the present embodiment can appropriately acquire the interest information of the user without requiring the means for acquiring the positional information, such as the GPS. Therefore, the guidance system 1 according to the present embodiment can present the guidance information tailored to the user with a higher degree of certainty according to appropriate interest information of the user.

In addition, the guidance method according to the present embodiment is a guidance method of the guidance system 1 that outputs the guidance information to the guidance map 20 that provides guidance about the guidance target, and includes a user specifying step and a guidance presentation step. In the user specifying step, the user specifying unit 131 specifies the user based on the image captured by the imaging device 2-M that can image the user near the guidance map 20. In the guidance presentation step, the guidance presentation unit 132 causes the guidance map 20 to output the guidance information about the area within the range of the guidance target having the attribute of a higher degree of interest of the specified user based on the interest information that is acquired from the interest information storage unit 123 that stores the interest information representing the degree of interest of the user and that corresponds to the user specified by the user specifying unit 131 and the attribute of the area within the range of the guidance target, which is acquired from the attribute information storage unit 321 that stores the attribute for each area.

Accordingly, the guidance method according to the present embodiment has the same effects as the guidance system 1 described above, and can provide appropriate guidance tailored to the user without requiring the means for acquiring the positional information, such as the GPS.

### Second Embodiment

Next, a guidance system 1a according to a second embodiment will be described with reference to the drawings.

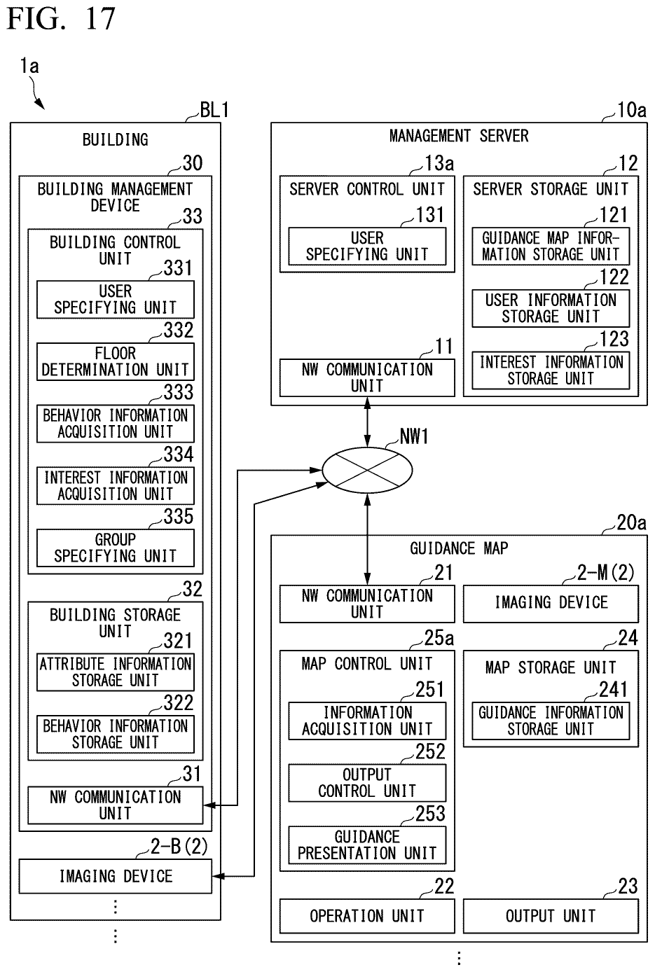

FIG. 17 is a functional block diagram showing an example of the guidance system 1a according to the second embodiment.

As shown in FIG. 17, the guidance system 1a includes the imaging device 2-B, a management server 10a, a guidance map 20a, and the building management device 30.

In the present embodiment, a modification example will be described in which the guidance map 20a generates the guidance information instead of the management server 10a.

In FIG. 17, the same configurations as the configurations shown in FIG. 2 described above are denoted by the same reference numerals, and the description thereof will be omitted.

The management server 10a is a server device that manages the entire guidance system 1a, and includes the NW communication unit 11, the server storage unit 12, and a server control unit 13a.

The server control unit 13a is a functional unit that is implemented, for example, by causing a processor including a CPU and the like to execute a program stored in a storage unit (not shown). The server control unit 13a integrally controls the management server 10a to execute various processes in the management server 10a.

The server control unit 13a includes the user specifying unit 131. The server control unit 13a has the same functions as the server control unit 13 according to the first embodiment except that the server control unit 13a does not include the guidance presentation unit 132.

The guidance map 20a includes the imaging device 2-M, the NW communication unit 21, the operation unit 22, the output unit 23, the map storage unit 24, and a map control unit 25a.

The map control unit 25a is a functional unit that is implemented, for example, by causing a processor including a CPU and the like to execute a program stored in a storage unit (not shown). The map control unit 25a integrally controls the guidance map 20a to execute various processes in the guidance map 20a. The map control unit 25a includes the information acquisition unit 251, the output control unit 252, and a guidance presentation unit 253.

The guidance presentation unit 253 has the same functions as the guidance presentation unit 132 according to the first embodiment described above. The guidance presentation unit 253 causes the guidance map 20a to output the guidance information about the area within the range of the guidance target having the attribute with a higher degree of interest of the specified user based on the interest information corresponding to the user and the attribute of the area within the range of the guidance target. The guidance presentation unit 253 causes the output unit 23 to output the guidance information via the output control unit 252.

Next, an operation of the guidance system 1a according to the present embodiment will be described with reference to the drawings.

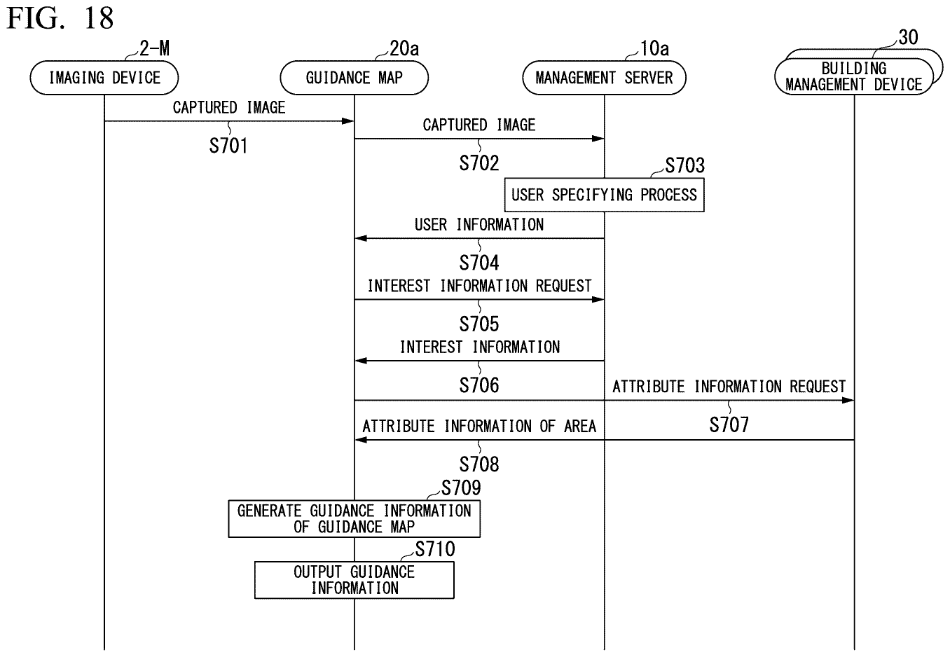

FIG. 18 is a diagram showing an example of the guidance process of the guidance system 1a according to the present embodiment.

In FIG. 18, since the processes from step S701 to step S703 are the same as the processes from step S501 to step S503 shown in FIG. 15, the description thereof will be omitted here.

Next, the server control unit 13a of the management server 10a transmits the user information (for example, the identification information of the user) indicating the user specified by the user specifying unit 131 to the guidance map 20a (step S704).

Next, the guidance presentation unit 253 of the guidance map 20a transmits the interest information request to the management server 10a (step S705). The interest information request includes the user information (for example, the identification information of the user) indicating the user specified by the user specifying unit 131.

Next, the server control unit 13a of the management server 10a acquires the interest information corresponding to the specified user from the interest information storage unit 123 in accordance with the interest information request, and transmits the interest information to the guidance map 20a (step S706).

The server control unit 13a of the management server 10a may omit the processes of step S704 and step S705 and execute the process of step S706.

Next, the guidance presentation unit 253 of the guidance map 20a transmits the attribute information request to the building management device 30 within the range of the guidance target of the guidance map 20a (step S707), and the building management device 30 transmits the attribute information of the area stored in the attribute information storage unit 321 to the guidance map 20a (step S708).

Next, the guidance presentation unit 253 of the guidance map 20a generates the guidance information of the guidance map 20a based on the interest information acquired from the management server 10a and the attribute information of the area acquired from the building management device 30 within the range of the guidance target (step S709).

Next, the guidance presentation unit 253 of the guidance map 20a causes the guidance map 20a to output the guidance information (step S710). The output control unit 252 of the guidance map 20a causes the guidance information that is generated by the guidance presentation unit 253 and that corresponds to the user specified by the user specifying unit 131 to be output from the output unit 23.

As described above, in the guidance system 1a according to the present embodiment, the guidance map 20a includes the guidance presentation unit 253. Accordingly, in the guidance system 1a according to the present embodiment, each guidance map 20a executes the process of generating the guidance information, so that the process can be distributed, and the processing load of the management server 10a can be reduced.

In addition, in the guidance system 1a according to the present embodiment, for example, it is possible to provide appropriate guidance tailored to the user without requiring the means for acquiring positional information such as the GPS, as in the first embodiment.

### Third Embodiment

Next, a guidance system 1b according to a third embodiment will be described with reference to the drawings.

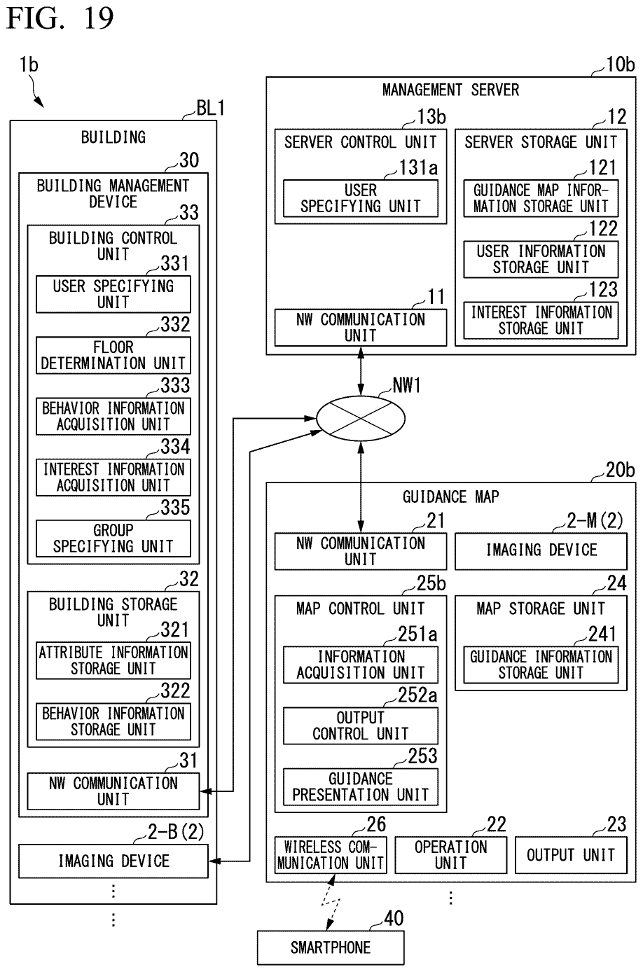

FIG. 19 is a functional block diagram showing an example of the guidance system 1b according to the third embodiment.

As shown in FIG. 19, the guidance system 1b includes the imaging device 2-B, a management server 10b, a guidance map 20b, the building management device 30, and a smartphone 40.

In the present embodiment, a modification example will be described in which the user is specified by using the unique identification information stored in the smartphone 40 in an auxiliary manner.

In FIG. 19, the same configurations as the configurations shown in FIG. 17 described above are denoted by the same reference numerals, and the description thereof will be omitted.

The management server 10b is a server device that manages the entire guidance system 1b, and includes the NW communication unit 11, the server storage unit 12, and a server control unit 13b.

The server control unit 13b is a functional unit that is implemented, for example, by causing a processor including a CPU and the like to execute a program stored in a storage unit (not shown). The server control unit 13b integrally controls the management server 10b to execute various processes in the management server 10b.

The server control unit 13b includes a user specifying unit 131a.

The user specifying unit 131a specifies the user based on the unique identification information received by the wireless communication unit 26 from the smartphone 40, which will be described later, and the image.

The guidance map 20b includes the imaging device 2-M, the NW communication unit 21, the operation unit 22, the output unit 23, the map storage unit 24, a map control unit 25b, and the wireless communication unit 26.

The wireless communication unit 26 is, for example, a functional unit that is implemented by a wireless communication device such as a wireless LAN. The wireless communication unit 26 performs communication with the smartphone 40. The wireless communication unit 26 receives, for example, the unique identification information, which is stored in the smartphone 40, from the smartphone 40.

The unique identification information is identification information for identifying the user, and is, for example, a device ID of a wireless LAN, a device ID of Bluetooth (registered trademark), an international mobile subscriber identity (IMSI) or an international mobile equipment identity (MEI) of the smartphone 40, and the like.

The map control unit 25b is a functional unit that is implemented, for example, by causing a processor including a CPU and the like to execute a program stored in a storage unit (not shown). The map control unit 25b integrally controls the guidance map 20b to execute various processes in the guidance map 20b. The map control unit 25b includes an information acquisition unit 251a, an output control unit 252a, and a guidance presentation unit 253.

The information acquisition unit 251a acquires various types of information related to the guidance map 20b. The information acquisition unit 251a acquires the captured image from the imaging device 2-M, and acquires the unique identification information from the smartphone 40 via the wireless communication unit 26. The information acquisition unit 251a transmits the acquired captured image and the unique identification information to the management server 10b via the NW communication unit 21. Since the other functions of the information acquisition unit 251a are the same as the functions of the information acquisition unit 251 according to the first embodiment described above, the description thereof will be omitted here.

The output control unit 252a causes the output unit 23 to output the guidance information and transmits the guidance information to the smartphone 40 via the wireless communication unit 26, and causes the smartphone 40 to output the guidance information.

The smartphone 40 is an example of a portable medium carried by the user. In addition, the smartphone 40 can communicate with the guidance map 20b via the wireless communication unit 26. The smartphone 40 stores the unique identification information and transmits the unique identification information to the guidance map 20b via the wireless communication unit 26. In addition, the smartphone 40 outputs the guidance information received from the guidance map 20b via the wireless communication unit 26. The smartphone 40 displays the guidance information on, for example, a display unit (not shown).

The smartphone 40 may be used instead of the operation unit 22 of the guidance map 20b.

In addition, in the guidance system 1b, in a case where the operation of designating a destination is performed by the user via the operation unit 22 of the guidance map 20b or the smartphone 40, the guidance presentation unit 253 may transmit the arrangement for calling the taxi to the vicinity of the guidance map 20b via the NW communication unit 21.

In addition, the guidance presentation unit 253 may automatically register a destination of the taxi by transmitting the destination designated by the operation unit 22 of the guidance map 20b or the smartphone 40 to the taxi that has arrived.

In addition, in a case where the group to which the user belongs is confirmed when the taxi is arranged, the guidance presentation unit 253 may arrange the taxi, including a user headcount of the group.

As described above, in the guidance system 1b according to the present embodiment, the guidance map 20b includes the wireless communication unit 26 (communication unit) that can receive the unique identification information stored in the smartphone 40 (portable medium) carried by the user. The user specifying unit 131a specifies the user based on the unique identification information received by the wireless communication unit 26 and the image captured by the imaging device 2-M.

Accordingly, in the guidance system 1b according to the present embodiment, the user is specified using a combination of the image captured by the imaging device 2-M and the unique identification information stored in the smartphone 40 (portable medium), and thus the user can be specified with higher accuracy. Therefore, the guidance system 1b according to the present embodiment can provide more appropriate guidance tailored to the user.

### Fourth Embodiment

Next, a guidance system 1c according to a fourth embodiment will be described with reference to the drawings.

In the present embodiment, a modification example applied to a case where a plurality of one-story stores (one store in one building) are included instead of the store in the building BL1 such as a building will be described.

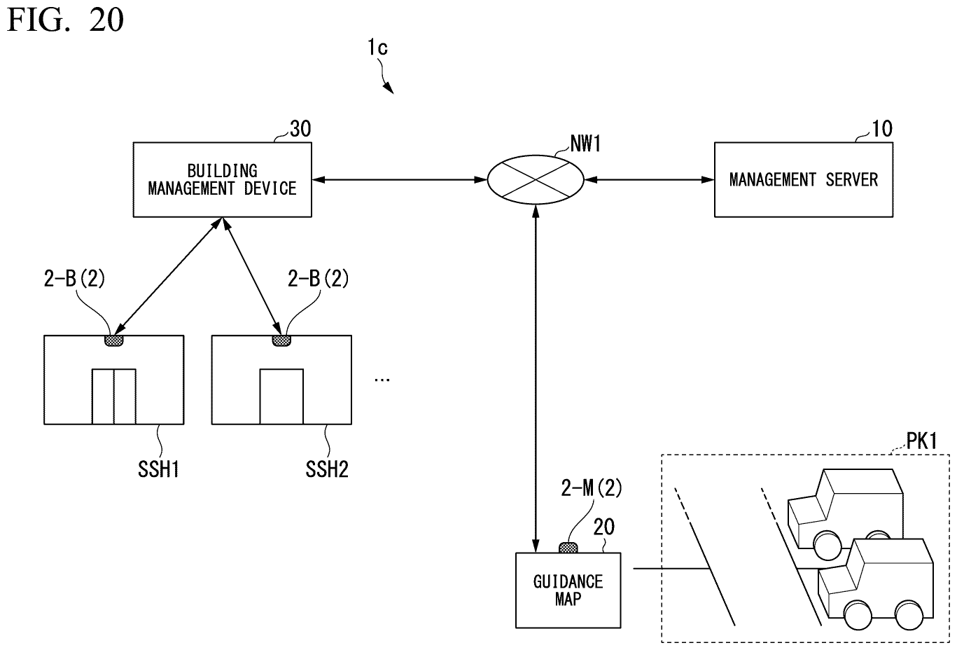

FIG. 20 is a configuration diagram showing an example of the guidance system 1c according to the fourth embodiment.

As shown in FIG. 20, the guidance system 1c includes the plurality of imaging devices 2 (2-B and 2-M), the management server 10, the guidance map 20, and the building management device 30. In the present embodiment, an example will be described in which the guidance map 20 is installed at an exit of a parking lot PK1.

In the present embodiment, at least one of the plurality of imaging devices 2-B is installed in a one-story building (SSH1, SSH2, . . . ) which is, for example, an independent store. At least one imaging device 2-B is installed near an entrance/exit of the building (SSH1, SSH2, . . . ), and it is possible to detect the entrance or exit of the user with respect to each store.

In addition, the building management device 30 according to the present embodiment is the same as the building management device 30 according to the first to third embodiments except that the building management device 30 manages the plurality of buildings (SSH1, SSH2, . . . ) instead of the building BL1 having the plurality of floors.

The building management device 30 according to the present embodiment manages the plurality of buildings (SSH1, SSH2, . . . ), determines the user who uses the plurality of buildings (SSH1, SSH2, . . . ), and acquires the behavior information and the interest information of the user.

The floor determination unit 332 according to the present embodiment determines the entrance or exit of the user with respect to each store by using the imaging device 2-B installed near the entrance/exit of the store, instead of the floor determination.

Since the other functions of the building management device 30 according to the present embodiment are the same as the functions of the building management device 30 according to the first to third embodiments, the description thereof will be omitted here. The building (SSH1, SSH2, . . . ) may include the plurality of imaging devices 2-B inside, and the building management device 30 tracks the user in the store by using the plurality of imaging devices 2-B to acquire the interest information of the user as in the first to third embodiments described above.

The guidance map 20 according to the present embodiment outputs the guidance information related to the stores of the plurality of buildings (SSH1, SSH2, . . . ) in accordance with the user.

In addition, since the management server 10 and the guidance map 20 according to the present embodiment are the same as the management server 10 and the guidance map 20 according to the first embodiment, the description thereof will be omitted here.

As described above, the guidance system 1c according to the present embodiment can appropriately provide the guidance about, for example, a region where there are many one-story buildings (SSH1, SSH2, . . . ) in accordance with the user.

Although the example has been described in which the building management device 30 manages the plurality of buildings (SSH1, SSH2, . . . ) in the present embodiment, the present invention is not limited to this, and the building management device 30 may manage the plurality of buildings in a mixed manner with the building BL1 of a multi-story building or the like.

Although the example has been described in which the guidance system 1c according to the present embodiment is applied to the first embodiment described above, the present invention is not limited to this, and the present embodiment may be applied to the second or third embodiment.

### Fifth Embodiment

Next, a guidance system 1d according to a fifth embodiment will be described with reference to the drawings.

In the present embodiment, a modification example will be described in which a user moves around the store of the guidance information by using a shared vehicle instead of the taxi.

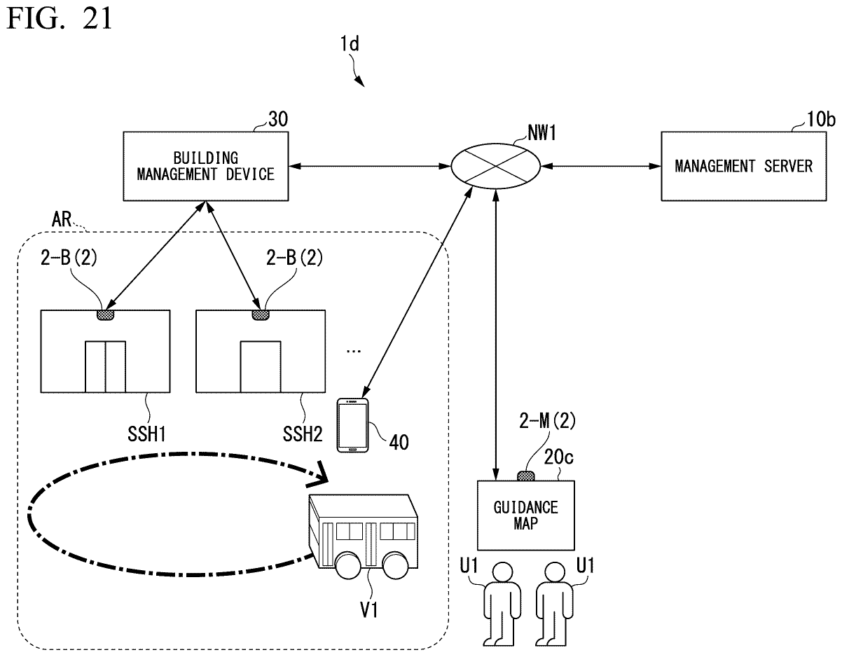

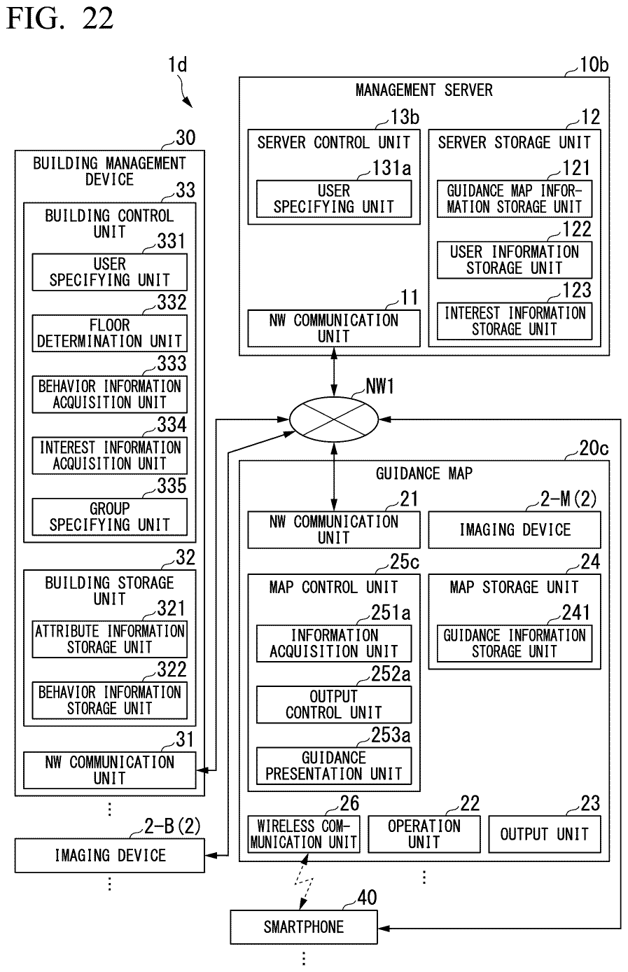

FIG. 21 is a configuration diagram showing an example of the guidance system 1d according to the fifth embodiment. In addition, FIG. 22 is a functional block diagram showing an example of the guidance system 1d according to the fifth embodiment.

As shown in FIGS. 21 and 22, the guidance system 1d includes the plurality of imaging devices 2 (2-B and 2-M), the management server 10b, a guidance map 20c, the building management device 30, and the smartphone 40.

In the present embodiment, the same configurations as the configurations shown in FIGS. 19 and 20 described above are denoted by the same reference numerals, and the description thereof will be omitted.

In the present embodiment, it is assumed that the guidance map 20c is installed, for example, near a riding/exit place of a shared vehicle V1.

The shared vehicle V1 is, for example, a shared bus or shared taxi that moves within a target area AR, ride-share, a shared arial vehicle (AV) including drones, or a shared vehicle such as a train or ship, in other words, a shared moving object (mobility) on which user U1 can board and move.

In addition, the target area AR is an area within the range of the guidance target, and is, for example, an area of a commercial facility, a tourist destination, or the like.

The guidance map 20c includes the imaging device 2-M, the NW communication unit 21, the operation unit 22, the output unit 23, the map storage unit 24, a map control unit 25c, and the wireless communication unit 26.

The map control unit 25c is a functional unit that is implemented, for example, by causing a processor including a CPU and the like to execute a program stored in a storage unit (not shown). The map control unit 25c integrally controls the guidance map 20c to execute various processes in the guidance map 20c. The map control unit 25c includes the information acquisition unit 251a, the output control unit 252a, and a guidance presentation unit 253a.

The guidance presentation unit 253a has the same function as the guidance presentation unit 253 according to the third embodiment described above and executes a process related to the shared vehicle V1. The guidance presentation unit 253a automatically registers the destination optimally designated via, for example, the operation unit 22 or the smartphone 40 carried by the user U1 in accordance with the request of the user U1 (destination designated on demand) as a destination of the shared vehicle V1.

Here, the designated destination includes a destination indicated by the guidance information output by the guidance map 20c. The guidance map 20c automatically registers the destination designated from the guidance information output from the guidance map 20c via the operation unit 22 or the smartphone 40 carried by each of the plurality of users U1, as the destination of the shared vehicle V1. As the designated destination, a plurality of destinations may be designated by one user U1.

In addition, the guidance presentation unit 253a automatically registers the designated destination as the destination of the shared vehicle V1, generates an optimal movement route corresponding to the destination of the shared vehicle V1, and sets the generated movement route to the shared vehicle V1. That is, the guidance presentation unit 253a generates the optimal movement route (traveling route in the target area AR) corresponding to the destination designated by the user U1, sets the traveling route for the shared vehicle V1, and arranges the shared vehicle V1.

The guidance presentation unit 253a may set, as the optimal movement route, a route such that, for example, a movement distance of the shared vehicle V1 is minimized, or a route such that, for example, a movement time of the shared vehicle V1 is minimized.

In addition, the guidance presentation unit 253a outputs (displays) a current position of the arranged shared vehicle V1, planned waypoints, and the traveling route (movement route) to the output unit 23, and displays the current position of the arranged shared vehicle V1, and the planned waypoints and the traveling route (movement route) on the smartphone 40. The guidance presentation unit 253a acquires the current position of the arranged shared vehicle V1 via, for example, the NW communication unit 21, and causes the output unit 23 to output the current position of the shared vehicle V1 and traveling information including the waypoints and the traveling route via the output control unit 252a.

In addition, the guidance presentation unit 253a transmits the traveling information including the current position of the shared vehicle V1, and the waypoints and the traveling route to the smartphone 40 of each user U1 who boards the shared vehicle V1 via the NW communication unit 21 or the wireless communication unit 26. The smartphone 40 of each user U1 displays the current position of the shared vehicle V1, the waypoints, and the traveling route based on the traveling information of the shared vehicle V1.

The user U1 who has boarded (ridden) the shared vehicle V1 can check the current position of the shared vehicle V1, and the waypoints and the traveling route by using the smartphone 40.

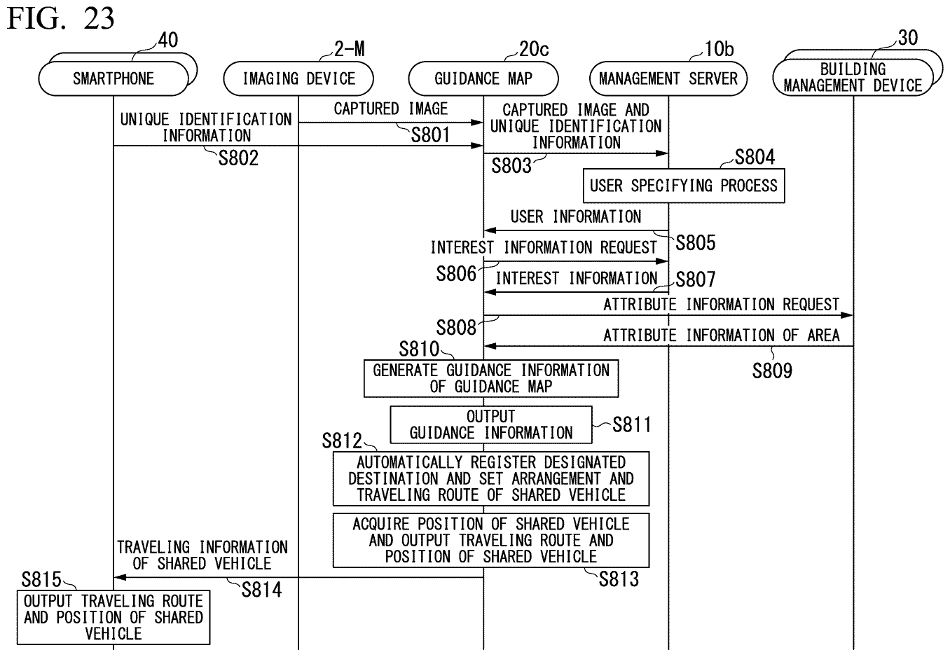

Next, an operation of the guidance system 1d according to the present embodiment will be described with reference to FIG. 23.

FIG. 23 is a diagram showing an example of the operation of the guidance system 1d according to the present embodiment.

As shown in FIG. 23, first, the imaging device 2-M transmits the captured image to the guidance map 20c (step S801). In addition, the smartphone 40 transmits the unique identification information to the guidance map 20c (step S802).

Next, the guidance map 20c transmits the captured image and the unique identification information to the management server 10b (step S803). That is, the information acquisition unit 251 of the guidance map 20c acquires the captured image of the vicinity of the guidance map 20c, which is captured by the imaging device 2-M, and the unique identification information received from the smartphone 40, and transmits the captured image and the unique identification information to the management server 10b via the NW communication unit 21.

Next, the user specifying unit 131a of the management server 10b executes the user specifying process (step S803). The user specifying unit 131a specifies the user based on the captured image of the vicinity of the guidance map 20c, which is captured by the imaging device 2-M, and the unique identification information.

Since the subsequent processes from step S805 to step S811 are the same as the processes from step S704 to step S710 shown in FIG. 18, the description thereof will be omitted here.

Next, the guidance presentation unit 253a of the guidance map 20c automatically registers the designated destination and sets the arrangement and the traveling route (traveling path) of the shared vehicle V1 (step S812). The guidance presentation unit 253a automatically registers the destination designated from the guidance information output by the guidance map 20c via the operation unit 22 or the smartphone 40 carried by the user U1, as the destination of the shared vehicle V1. In addition, the guidance presentation unit 253a sets the optimal traveling route for the shared vehicle V1 such that the movement distance or the movement time of the shared vehicle V1 is minimized.

Next, the guidance presentation unit 253a acquires the position of the shared vehicle V1, and outputs the traveling route and the position of the shared vehicle V1 (step S813). The guidance presentation unit 253a acquires the current position of the arranged shared vehicle V1 via the NW communication unit 21, and causes the output unit 23 to output the current position of the shared vehicle V1, and the waypoints and the traveling route via the output control unit 252a.

Next, the guidance presentation unit 253a transmits the traveling information of the shared vehicle V1 to the smartphone 40 (step S814). The guidance presentation unit 253a transmits the traveling information including the current position of the shared vehicle V1, and the waypoints and the traveling route to the smartphone 40 via the NW communication unit 21 or the wireless communication unit 26.

The smartphone 40 outputs the traveling route and the position of the shared vehicle V1 (step S815). The smartphone 40 displays the traveling route and the position of the shared vehicle V1 on, for example, a display unit (not shown) based on the received traveling information.

Although the example has been described in which the management server 10b specifies the user U1 based on the captured image and the unique identification information in the example shown in FIG. 23 described above, the management server 10b may specify the user U1 based on the captured image without using the unique identification information.

As described above, in the guidance system 1d according to the present embodiment, the guidance map 20c includes the operation unit 22, and the destination optimally designated in accordance with the request of the user U1 is automatically registered as the destination of the shared vehicle V1 via the operation unit 22 or the smartphone 40 (portable medium) carried by the user U1.

Accordingly, the guidance system 1d according to the present embodiment can provide appropriate guidance tailored to the user U1, and can move the user U1 by using the shared vehicle V1 to the destination optimally designated in accordance with the request of the user U1.

In addition, in the present embodiment, the guidance map 20c automatically registers the designated destination as the destination of the shared vehicle V1, generates the optimal movement route (for example, traveling route) corresponding to the destination of the shared vehicle V1, and sets the generated movement route in the shared vehicle V1.

Accordingly, in the guidance system 1d according to the present embodiment, the user U1 can be efficiently moved to the destination optimally designated in accordance with the request of the user U1 according to the optimal movement route.

In addition, in the present embodiment, the designated destination includes the destination indicated by the guidance information output by the guidance map 20c. The guidance map 20c automatically registers the destination designated from the guidance information as the destination of the shared vehicle V1 via the operation unit 22 or the smartphone 40 carried by each of the plurality of users U1.

Accordingly, the guidance system 1d according to the present embodiment can more appropriately move the user U1 to the destination indicated by the guidance information, and can improve the convenience.

In addition, in the present embodiment, the guidance map 20c displays the current position of the shared vehicle V1, the planned waypoints, and the movement route, and displays the current position of the shared vehicle V1, and the planned waypoint and the movement route on the smartphone 40.

Accordingly, in the guidance system 1d according to the present embodiment, it is possible to check the current position of the shared vehicle V1 until the arranged shared vehicle V1 comes near the guidance map 20c, and it is possible to check the current position, the planned waypoints, and the movement route via the smartphone 40 while the user U1 is moving by the shared vehicle V1.

In addition, in the guidance method according to the present embodiment, the guidance map 20c includes the operation unit 22, and the destination optimally designated in accordance with the request of the user U1 is automatically registered as the destination of the shared vehicle V1 via the operation unit 22 or the smartphone 40 (portable medium) carried by the user U1.

Accordingly, the guidance method according to the present embodiment has the same effects as the guidance system 1d described above, and can provide appropriate guidance tailored to the user U1 and can move the user U1 to the destination optimally designated in accordance with the request of the user U1 by using the shared vehicle V1.

### Sixth Embodiment

Next, a guidance system 1e according to a sixth embodiment will be described with reference to the drawings.

In the present embodiment, a modification example will be described in which the destination such as returning home and making a detour is directly set by the user U1 in the fifth embodiment described above, and the shared vehicle V1 is made to travel.

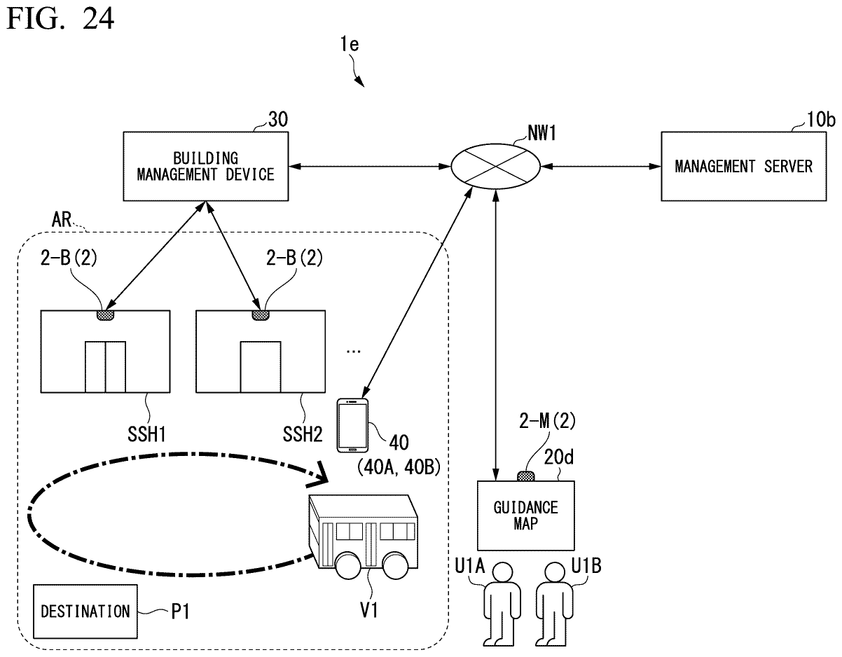

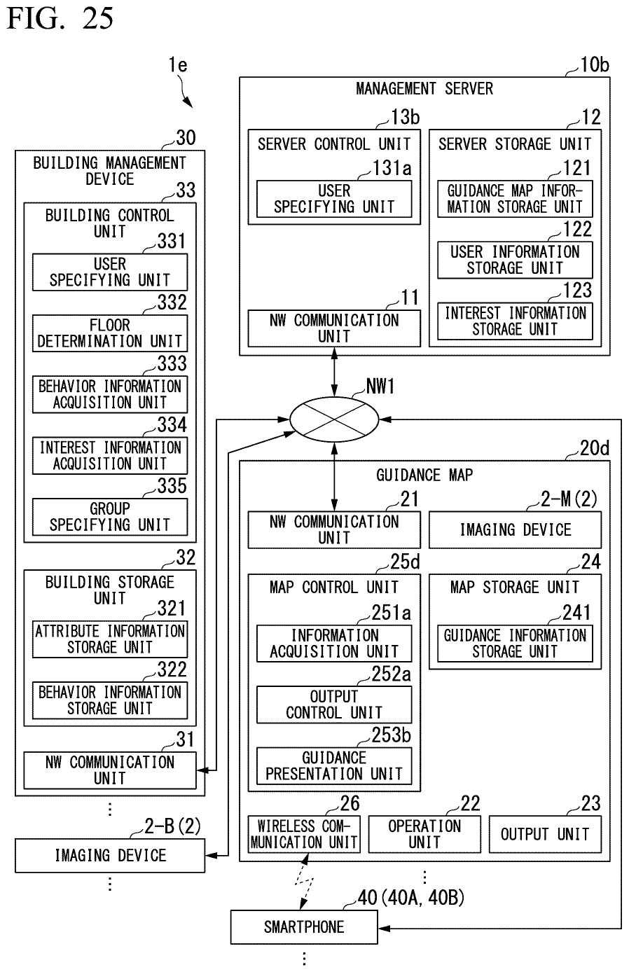

FIG. 24 is a configuration diagram showing an example of the guidance system 1e according to the sixth embodiment. In addition, FIG. 25 is a functional block diagram showing an example of the guidance system 1e according to the sixth embodiment.

As shown in FIGS. 24 and 25, the guidance system 1e includes the plurality of imaging devices 2 (2-B and 2-M), the management server 10b, a guidance map 20d, the building management device 30, and the smartphone 40 (40A and 40B).

In the present embodiment, the same configurations as the configurations shown in FIGS. 21 and 22 described above are denoted by the same reference numerals, and the description thereof will be omitted.

In the present embodiment, it is assumed that the guidance map 20d is installed, for example, near the riding/exit place of the shared vehicle V1.

In the present embodiment, as shown in FIG. 24, the user U1 includes a user U1A and a user U1B. Further, the smartphone 40 carried by the user U1A will be referred to as a smartphone 40A, and the smartphone 40 carried by the user U1B will be referred to as a smartphone 40B.

The guidance map 20d includes the imaging device 2-M, the NW communication unit 21, the operation unit 22, the output unit 23, the map storage unit 24, a map control unit 25d, and the wireless communication unit 26.

The map control unit 25d is a functional unit that is implemented, for example, by causing a processor including a CPU and the like to execute a program stored in a storage unit (not shown). The map control unit 25d integrally controls the guidance map 20d to execute various processes in the guidance map 20d. The map control unit 25d includes the information acquisition unit 251a, the output control unit 252a, and a guidance presentation unit 253b.

The guidance presentation unit 253b has the same function as the guidance presentation unit 253a according to the fifth embodiment described above, and executes a process of directly setting the destination of the shared vehicle V1 by the user U1. The guidance presentation unit 253b automatically registers the destination optimally designated via, for example, the operation unit 22 or the smartphone 40 carried by the user U1 in accordance with the request of the user U1 (destination designated on demand), as the destination of the shared vehicle V1.

In addition, the designated destination includes a designated place (for example, the destination P1) of which the positional information is directly designated via the operation unit 22 or the smartphone 40. Here, the destination P1 is home of the user U1, a returning destination such as the user U1's home or accommodation, or a detour destination. In a case where the designated destination is the designated place (directly designated destination P1 or the like), the guidance presentation unit 253b automatically registers the designated place as the destination of the shared vehicle V1 and stops the output of the guidance information corresponding to the user U1 who has designated the designated place.

For example, in a case where the destination P1 is designated as the designated place according to the operation of the smartphone 40A by the user U1A, the guidance presentation unit 253b stops the output of the guidance information corresponding to the user U1A and outputs the information on the destination P1.

The guidance presentation unit 253b may stop the output of the information on the destination P1 according to the operation of the smartphone 40A of the user U1A or the operation of the operation unit 22.

In addition, the guidance presentation unit 253b automatically registers the designated destination (destination P1 or the destination designated from the guidance information) as the destination of the shared vehicle V1, generates the optimal movement route corresponding to the destination of the shared vehicle V1, and sets the generated movement route in the shared vehicle V1.

The guidance presentation unit 253b may set, as the optimal movement route, the route such that, for example, the movement distance of the shared vehicle V1 is minimized, or the route such that, for example, a movement time of the shared vehicle V1 is minimized.

In addition, the guidance presentation unit 253b outputs (displays) the current position of the arranged shared vehicle V1, the planned waypoints, and the traveling route (movement route) to the output unit 23, and displays the current position of the arranged shared vehicle V1, and the planned waypoints and the traveling route (movement route) on the smartphone 40. The guidance presentation unit 253b may stop the display of a place corresponding to the destination P1 among the planned waypoints according to the operation of the smartphone 40A of the user U1A or the operation of the operation unit 22.

In this way, the guidance presentation unit 253b may stop the display of part or entirety of the waypoints and the movement route in accordance with the operation of the operation unit 22 or the smartphone 40.

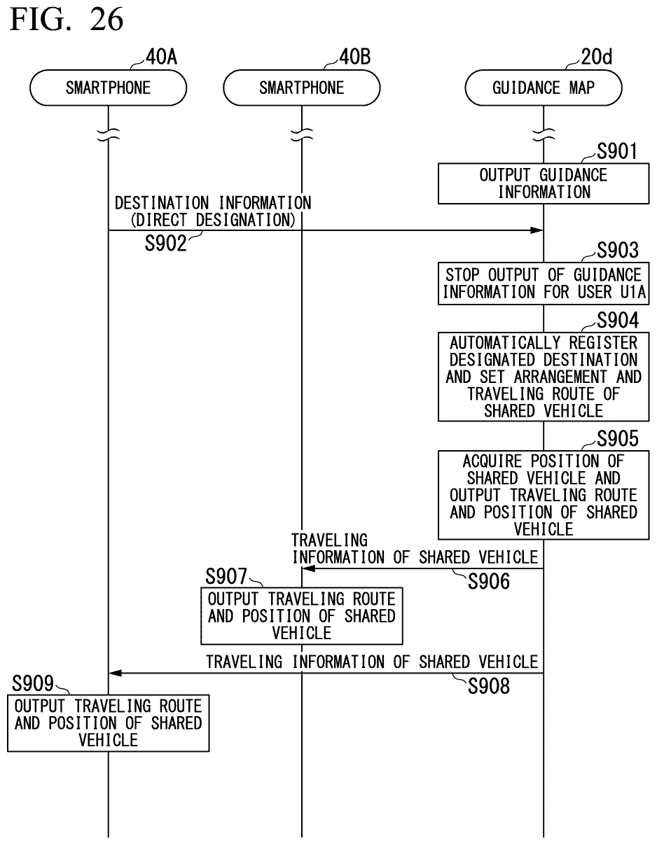

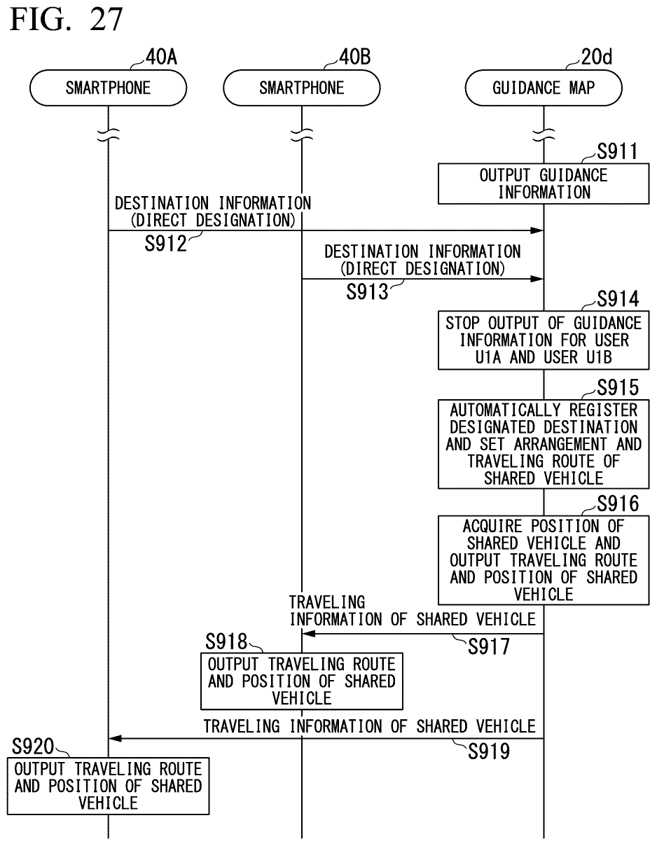

Next, an operation of the guidance system 1e according to the present embodiment will be described with reference to FIGS. 26 and 27.

FIG. 26 is a diagram showing an example of the operation of the guidance system 1e according to the present embodiment. Here, an example of the operation in a case where the user U1A directly designates the destination P1 and the user U1B designates the destination from the guidance information will be described.

As shown in FIG. 26, the guidance map 20d outputs the guidance information (step S901). Since the processes until the guidance map 20d outputs the guidance information are the same as the processes from step S801 to step S811 shown in FIG. 23 described above, the description thereof will be omitted here. The guidance map 20d outputs, for example, the guidance information for the user U1A and the user U1B to the output unit 23.

Next, the smartphone 40A transmits destination information to the guidance map 20d (step S902). According to the operation of the user U1A, the smartphone 40A transmits the destination information of the destination P1 directly designated by the user U1A to the guidance map 20d.

Next, the guidance presentation unit 253b of the guidance map 20d stops the output of the guidance information to the user U1A (step S903). The guidance presentation unit 253b may output the destination information of the destination P1 instead of the guidance information for the user U1A.

Next, the guidance presentation unit 253b automatically registers the designated destination and sets the arrangement and the traveling route (traveling path) of the shared vehicle V1 (step S904). Here, it is assumed that the user U1B designates the destination of the guidance information. The guidance presentation unit 253b automatically registers the destination designated from the guidance information output from the guidance map 20d and the destination P1 directly designated by the user U1A via the operation unit 22 or the smartphone 40B carried by the user U1B, as the destination of the shared vehicle V1. In addition, the guidance presentation unit 253b sets the optimal traveling route in the shared vehicle V1 such that the movement distance or the movement time of the shared vehicle V1 is minimized.

Next, the guidance presentation unit 253b acquires the position of the shared vehicle V1, and outputs the traveling route and the position of the shared vehicle V1 (step S905). The guidance presentation unit 253b acquires the current position of the arranged shared vehicle V1 via the NW communication unit 21, and causes the output unit 23 to output the current position of the shared vehicle V1, and the waypoints and the traveling route via the output control unit 252a.

Next, the guidance presentation unit 253b transmits the traveling information of the shared vehicle V1 to the smartphone 40A (step S906), and the smartphone 40A outputs the traveling route and the position of the shared vehicle V1 (step S907). The smartphone 40A displays the traveling route and the position of the shared vehicle V1 on, for example, a display unit (not shown) based on the received traveling information.

In addition, the guidance presentation unit 253b transmits the traveling information of the shared vehicle V1 to the smartphone 40B (step S908), and the smartphone 40B outputs the traveling route and the position of the shared vehicle V1 (step S909). The smartphone 40B displays the traveling route and the position of the shared vehicle V1 on, for example, a display unit (not shown) based on the received traveling information.

The guidance presentation unit 253b may stop the display of the place corresponding to the destination P1 among the planned waypoints according to the operation of the smartphone 40A of the user U1A or the operation of the operation unit 22.

FIG. 27 is a diagram showing another example of the operation of the guidance system 1e according to the present embodiment. Here, an example of an operation in a case where both the user U1A and the user U1B directly designate the designated place such as the destination P1 will be described.

As shown in FIG. 27, the guidance map 20d outputs the guidance information (step S911). Since the processes until the guidance map 20d outputs the guidance information are the same as the processes from step S801 to step S811 shown in FIG. 23 described above, the description thereof will be omitted here. The guidance map 20d outputs, for example, the guidance information for the user UIA and the user U1B to the output unit 23.

Next, the smartphone 40A transmits the destination information to the guidance map 20d (step S912).

In addition, the smartphone 40B transmits the destination information to the guidance map 20d (step S913).

Next, the guidance presentation unit 253b of the guidance map 20d stops the output of the guidance information to the user U1A and the user U1B (step S914). The guidance presentation unit 253b may output the destination information of the user U1A and the user U1B instead of the guidance information for the user U1A and the user U1B.

Next, the guidance presentation unit 253b automatically registers the designated destination and sets the arrangement and the traveling route (traveling path) of the shared vehicle V1 (step S915). The guidance presentation unit 253b automatically registers the destination directly designated by each of the user U1A and the user U1B, as the destination of the shared vehicle V1. In addition, the guidance presentation unit 253b sets the optimal traveling route in the shared vehicle V1 such that the movement distance or the movement time of the shared vehicle V1 is minimized.

Next, the guidance presentation unit 253b acquires the position of the shared vehicle V1, and outputs the traveling route and the position of the shared vehicle V1 (step S916).

Since the processes from step S917 to step S920 are the same as the processes from step S906 to step S909 shown in FIG. 26, the description thereof will be omitted here.

The guidance presentation unit 253b may stop the display of the place corresponding to the destination directly designated by the user U1A among the planned waypoints according to the operation of the smartphone 40A of the user U1A or the operation of the operation unit 22. In addition, the guidance presentation unit 253b may stop the display of the place corresponding to the destination directly designated by the user U1B among the planned waypoints according to the operation of the smartphone 40B of the user U1B or the operation of the operation unit 22.

As described above, in the guidance system 1e according to the present embodiment, the above-described designated destination includes the designated place of which the positional information is directly designated via the operation unit 22 or the smartphone 40. In a case where the designated destination is the designated place, the guidance map 20d automatically registers the designated place as the destination of the shared vehicle V1 and stops the output of the guidance information corresponding to the user U1 who has designated the designated place.

Accordingly, the guidance system 1e according to the present embodiment can move to the destination such as returning home and making a detour by using the shared vehicle V1, and can further improve the convenience.

In addition, in the present embodiment, the guidance map 20d may stop the display of part or entirety of the waypoints and the movement route in accordance with the operation of the operation unit 22 or the smartphone 40.

Accordingly, the guidance system 1e according to the present embodiment can stop the display of the destination in a case of returning home or making a detour, for example, and can ensure the privacy of the user U1.

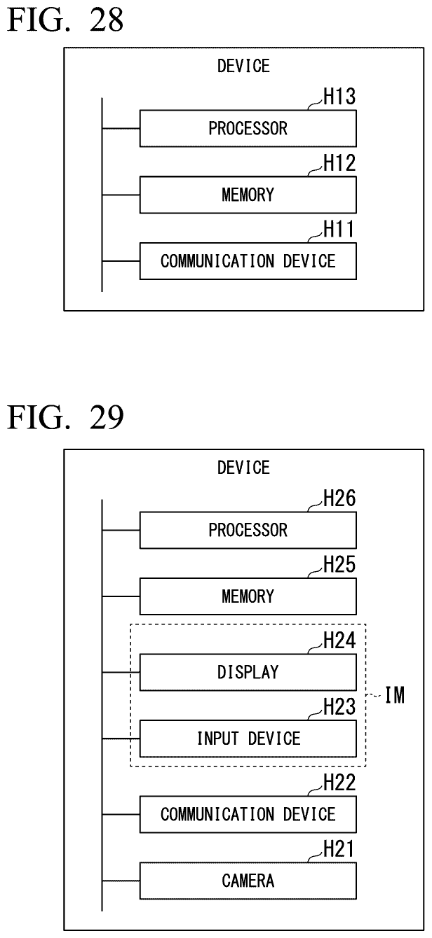

FIGS. 28 and 29 are diagrams showing a hardware configuration of each device of the guidance system 1 (1a, 1b, 1c, 1d, and 1e) according to the embodiment.

FIG. 28 shows a hardware configuration of each device of the management server 10 (10a and 10b) and the building management device 30.

As shown in FIG. 28, each device of the management server 10 (10a and 10b) and the building management device 30 includes a communication device H11, a memory H12, and a processor H13.

The communication device H11 is, for example, a communication device that is connectable to the network NW1, such as a LAN card.

The memory H12 is, for example, a storage device such as a RAM, a flash memory, a high bandwidth memory (HBM), or an HDD, and stores various types of information and programs used by each device of the management server 10 (10a and 10b) and the building management device 30.

The processor H13 is, for example, a processing circuit including a CPU, a graphics processing unit (GPU), a general purpose computing on graphics processing unit (GPGPU), a tensor processing unit (TPU), and the like. The processor H13 executes various processes of each device of the management server 10 (10a and 10b) and the building management device 30 by executing the program stored in the memory H12.

In addition, FIG. 29 shows a hardware configuration of each device of the guidance map 20 (20a, 20b, 20c, and 20d).

As shown in FIG. 29, each device of the guidance map 20 (20a, 20b, 20c, and 20d) includes a camera H21, a communication device H22, an input device H23, a display H24, a memory H25, and a processor H26.

The camera H21 includes, for example, a CCD image sensor and implements the imaging device 2-M described above.

The communication device H22 is, for example, a communication device such as a LAN card, a wireless LAN card, or a mobile communication device that is connectable to the network NW1.

The input device H23 is, for example, an input device such as a switch, a button, a touch sensor, or a noncontact sensor.

The display H24 is, for example, a display device such as a liquid crystal display or an organic electro-luminescence (EL) display.

The input device H23 and the display H24 constitute, for example, a guidance map board IM of the guidance maps 20 (20a, 20b, 20c, and 20d).

The memory H25 is, for example, a storage device such as a RAM, a flash memory, or an HDD, and stores various types of information and a program used by each device of the guidance map 20 (20a, 20b, 20c, and 20d).

The processor H26 is, for example, a processing circuit including a CPU and the like. The processor H26 executes various processes of each device of the guidance map 20 (20a, 20b, 20c, and 20d) by executing the program stored in the memory H25.

It should be noted that the present disclosure is not limited to each of the above-described embodiments and can be modified without departing from the gist of the present disclosure.

For example, in each of the above-described embodiments, the example has been described in which the guidance system 1 (1a, 1b, 1c, 1d, and 1e) includes the management server 10 (10a and 10b) and the building management device 30, but the present invention is not limited to this. The management server 10 (10a and 10b) and the building management device 30 may be integrated into one device, or part of the building management device 30 may be provided in the management server 10 (10a and 10b).

In addition, in each of the above-described embodiments, the example has been described in which the management server 10 (10a and 10b) includes the user specifying unit 131 (131a), but the guidance map 20 (20a, 20b, 20c, and 20d) may have the function of the user specifying unit 131 (131a).

In addition, the management server 10 (10a and 10b) may be a cloud server using cloud technology.

In addition, in each of the above-described embodiments, the example has been described in which the guidance map 20 (20a, 20b, 20c, and 20d) includes the imaging device 2-M, but the present invention is not limited to this, and the imaging device 2-M may be independently provided. In this case, the imaging device 2-M may be directly connected to the network NW1, as in the imaging device 2-B.

In addition, in the fifth and sixth embodiments described above, the example has been described in which the user U1 is specified by using the captured image and the unique identification information, but the present invention is not limited to this, and the user U1 may be specified from the captured image without using the unique identification information.

Each configuration of the above-described guidance system 1 (1a, 1b, 1c, 1d, and 1e) includes a computer system inside. Then, a program for implementing the functions of each configuration of the guidance system 1 (1a, 1b, 1c, 1d, 1e) described above may be recorded on a computer-readable recording medium, the program recorded on the recording medium may be read by the computer system, and the program may be executed to perform the process in each configuration of the guidance system 1 (1a, 1b, 1c, 1d, 1e) described above. Here, the configuration “the computer system reads the program recorded ON the recording medium to execute the program” includes installing the program in the computer system. Here, the term “computer system” includes an operating system (OS) and hardware such as a peripheral device.

In addition, the term “computer system” may include a plurality of computer devices connected via a network including a communication line such as the Internet, a WAN, a LAN, or a dedicated line. Also, the term “computer-readable recording medium” refers to a portable medium, such as a flexible disk, a magneto-optical disk, an ROM, or a CD-ROM, and a storage device, such as a hard disk incorporated in the computer system. As described above, the recording medium on which the program is stored may be a non-transitory recording medium such as a CD-ROM.

In addition, the recording medium also includes an internal or external recording medium that is accessible by a distribution server for distributing the program. The program may be divided into a plurality of parts, downloaded at different timings, and then combined into each configuration of the guidance system 1 (1a, 1b, 1c, 1d, and 1e), or the divided programs may be distributed by different distribution servers. Further, the term “computer-readable recording medium” also includes a medium that stores the program for a certain time, such as a volatile memory (RAM) inside the computer system that serves as a server or a client in a case where the program is transmitted via a network. In addition, the above-described program may be a program for implementing some of the above-described functions. Further, the program may be a so-called difference file (difference program) capable of implementing the above-described functions in combination with a program that has already been recorded on the computer system.

Hereinafter, various aspects of the present disclosure will be collectively described in a form of supplementary notes.

### (Supplementary Note 1)

A guidance system including: a user specifying unit configured to, based on an image captured by an imaging device configured to image a user near a guidance map that provides guidance about a guidance target, specify the user; and a guidance presentation unit configured to, based on interest information that represents a degree of interest of the user, that is acquired from an interest information storage unit configured to store the interest information, and that corresponds to the user specified by the user specifying unit, and an attribute of an area within a range of the guidance target, which is acquired from an attribute information storage unit configured to store the attribute for each area, cause the guidance map to output guidance information about the area within the range of the guidance target having an attribute with a higher degree of interest of the specified user.

### (Supplementary Note 2)

The guidance system according to Supplementary Note 1, in which the user specifying unit specifies the user based on a feature value extracted from the image.

### (Supplementary Note 3)

The guidance system according to Supplementary Note 1 or 2, in which the user specifying unit specifies the user based on a learning result obtained by machine learning using training data in which the user specified in advance and an image in which the user is imaged are associated with each other.

### (Supplementary Note 4)

The guidance system according to any one of Supplementary Notes 1 to 3, in which the guidance map includes a communication unit configured to receive unique identification information stored in a portable medium carried by the user, and the user specifying unit specifies the user based on the unique identification information received by the communication unit and the image.

### (Supplementary Note 5)

The guidance system according to any one of Supplementary Notes 1 to 4, in which, in a case where a group including the specified user is confirmed, the guidance presentation unit causes the guidance map to output the guidance information about the area within the range of the guidance target having an attribute with a higher degree of interest of the group.

### (Supplementary Note 6)

The guidance system according to Supplementary Note 5, in which, in a case where at least a preset number of the users belonging to the group are specified, the guidance presentation unit causes the guidance map to output the guidance information about the area within the range of the guidance target having the attribute with the higher degree of interest of the group.

### (Supplementary Note 7)

The guidance system according to Supplementary Note 5, in which, in a case where at least a preset proportion of the users belonging to the group are specified, the guidance presentation unit causes the guidance map to output the guidance information about the area within the range of the guidance target having the attribute with the higher degree of interest of the group.

### (Supplementary Note 8)

The guidance system according to any one of Supplementary Notes 1 to 7, in which the guidance system includes the guidance map including an output unit configured to output the guidance information, and the guidance presentation unit causes the output unit to output the guidance information.

### (Supplementary Note 9)

The guidance system according to Supplementary Note 8, in which the guidance map includes the guidance presentation unit.

### (Supplementary Note 10)

The guidance system according to Supplementary Note 8, further including: a server device that is connectable to the guidance map via a network, in which the server device includes the interest information storage unit and the guidance presentation unit, and the guidance presentation unit causes the output unit of the guidance map to output the guidance information via the network.

### (Supplementary Note 11)

The guidance system according to any one of Supplementary Notes 1 to 10, further including: a first imaging device that is the imaging device configured to image the user near the guidance map; a plurality of second imaging devices installed in a building within the range of the guidance target; a floor determination unit configured to determine an arrival floor of the user among a plurality of floors in the building based on an image captured by at least any of the plurality of second imaging devices while the user is moving; a behavior information acquisition unit configured to acquire behavior information representing behavior of the user on the arrival floor determined by the floor determination unit, based on the image captured by at least any of the plurality of second imaging devices; and an interest information acquisition unit configured to acquire the interest information representing a degree of interest of the user for each attribute based on disposition and the attribute of the area on the arrival floor determined by the floor determination unit and the behavior information acquired by the behavior information acquisition unit, and store the interest information in the interest information storage unit for each user.

### (Supplementary Note 12)

The guidance system according to Supplementary Note 1, in which the guidance map includes an operation unit of the guidance map, and automatically registers a destination designated via the operation unit or a portable medium carried by the user, as a destination of a taxi.

### (Supplementary Note 13)

The guidance system according to Supplementary Note 12, in which the guidance map arranges the taxi, including a user headcount of the group to which the user belongs.

### (Supplementary Note 14)

The guidance system according to Supplementary Note 1, in which the guidance map includes an operation unit of the guidance map, and automatically registers a destination designated in accordance with a request of the user via the operation unit or a portable medium carried by the user, as a destination of a shared vehicle.

### (Supplementary Note 15)

The guidance system according to Supplementary Note 14, in which the guidance map automatically registers the designated destination as the destination of the shared vehicle, generates an optimal movement route corresponding to the destination of the shared vehicle, and sets the generated movement route in the shared vehicle.

### (Supplementary Note 16)

The guidance system according to Supplementary Note 15, in which the designated destination includes a destination indicated by the guidance information output by the guidance map, and the guidance map automatically registers a destination designated from the guidance information via the operation unit or the portable medium carried by each of a plurality of the users, as the destination of the shared vehicle.

### (Supplementary Note 17)

The guidance system according to Supplementary Note 16, in which the designated destination includes a designated place of which positional information is directly designated via the operation unit or the portable medium, and in a case where the designated destination is the designated place, the guidance map automatically registers the designated place as the destination of the shared vehicle, and stops output of the guidance information corresponding to the user who has designated the designated place.

### (Supplementary Note 18)

The guidance system according to Supplementary Note 17, in which the guidance map displays a current position of the shared vehicle, planned waypoints, and the movement route, and displays the current position of the shared vehicle, the planned waypoints, and the movement route on the portable medium.

### (Supplementary Note 19)

The guidance system according to Supplementary Note 18, in which the guidance map stops display of part or entirety of the waypoints and the movement route in accordance with an operation of the operation unit or the portable medium.

### (Supplementary Note 20)

A guidance method of a guidance system configured to output guidance information to a guidance map that provides guidance about a guidance target, the guidance method including: via a user specifying unit, based on an image captured by an imaging device configured to image a user near the guidance map, specifying the user; and via a guidance presentation unit, based on interest information that represents a degree of interest of the user, that is acquired from an interest information storage unit configured to store the interest information, and that corresponds to the user specified by the user specifying unit, and an attribute of an area within a range of the guidance target, which is acquired from an attribute information storage unit configured to store the attribute for each area, causing the guidance map to output the guidance information about the area within the range of the guidance target having an attribute with a higher degree of interest of the specified user.

### (Supplementary Note 21)

The guidance method according to Supplementary Note 20, in which the guidance map includes an operation unit of the guidance map, and automatically registers a destination designated via the operation unit or a portable medium carried by the user, as a destination of a taxi.

### (Supplementary Note 22)

The guidance method according to Supplementary Note 21, in which the guidance map arranges the taxi, including a user headcount of the group to which the user belongs.

### (Supplementary Note 23)

The guidance method according to Supplementary Note 20, in which the guidance map includes an operation unit of the guidance map, and automatically registers a destination designated in accordance with a request of the user via the operation unit or a portable medium carried by the user, as a destination of a shared vehicle.

### (Supplementary Note 24)

The guidance method according to Supplementary Note 23, in which the guidance map automatically registers the designated destination as the destination of the shared vehicle, generates an optimal movement route corresponding to the destination of the shared vehicle, and sets the generated movement route in the shared vehicle.

### (Supplementary Note 25)

The guidance method according to Supplementary Note 24, in which the designated destination includes a destination included in the guidance information, and the guidance map automatically registers a destination designated via the operation unit or the portable medium carried by each of a plurality of the users, as the destination of the shared vehicle.

### (Supplementary Note 26)

The guidance method according to Supplementary Note 25, in which the designated destination includes a designated place of which positional information is directly designated via the operation unit or the portable medium, and in a case where the designated destination is the designated place, the guidance map automatically registers the designated place as the destination of the shared vehicle, and stops output of the guidance information corresponding to the user who has designated the designated place.

### (Supplementary Note 27)

The guidance method according to Supplementary Note 26, in which the guidance map displays a current position of the shared vehicle, planned waypoints, and the movement route, and displays the current position of the shared vehicle, the planned waypoints, and the movement route on the portable medium.

### (Supplementary Note 28)

The guidance method according to Supplementary Note 27, in which the guidance map stops display of part or entirety of the waypoints and the movement route in accordance with an operation of the operation unit or the portable medium.

### REFERENCE SIGNS LIST

1, 1a, 1b, 1c, 1d, 1e Guidance system
2, 2-B, 2-M Imaging device
10, 10a, 10b Management server
11, 21, 31 NW communication unit
12 Server storage unit
13, 13a, 13b Server control unit
20, 20a, 20b, 20c, 20d Guidance map
22 Operation unit
23 Output unit
24 Map storage unit
25, 25a, 25b, 25c, 25d Map control unit
26 Wireless communication unit
30 Building management device
32 Building storage unit
33 Building control unit
40, 40A, 40B Smartphone
121 Guidance map information storage unit
122 User information storage unit
123 Interest information storage unit
131, 131a User specifying unit
132, 253, 253a, 253b Guidance presentation unit
241 Guidance information storage unit
251, 251a Information acquisition unit
252, 252a Output control unit
321 Attribute information storage unit
322 Behavior information storage unit
331 User specifying unit
332 Floor determination unit
333 Behavior information acquisition unit
334 Interest information acquisition unit
335 Group specifying unit
NW1 Network
BL1 Building
EV1 Elevator
ESL1 Escalator
GT1 Ticket gate
HM1 Platform
P1 Destination
STR1 Stairs
ST1 Station
ST-1, ST-2 Store
PK1 Parking lot
U1, U1A, U1B User
V1 Shared vehicle

1. A guidance system comprising:
user specifying circuitry configured to, based on an image captured by an imaging device configured to image a user near a guidance map that includes a display and a processor and provides guidance about a guidance target, specify the user; and
guidance presentation circuitry configured to, based on interest information and an attribute of an area within a range of the guidance target, cause the guidance map to output guidance information about the area within the range of the guidance target having an attribute with a higher degree of interest of the user specified by the user specifying circuitry,
wherein the guidance information represents a degree of interest of the user, is acquired from an interest information storage medium configured to store the interest information, and corresponds to the user specified by the user specifying circuitry,
the attribute is acquired from an attribute information storage medium configured to store the attribute for each area, and
the guidance map includes operation circuitry of the guidance map, and automatically registers a destination designated via the operation circuitry or a portable medium carried by the user, as a destination of a taxi.

2. The guidance system according to claim 1,
wherein the user specifying circuitry specifies the user based on a feature value extracted from the image.

3. The guidance system according to claim 1,
wherein the user specifying circuitry specifies the user based on a learning result obtained by machine learning using training data in which the user specified in advance and an image in which the user is imaged are associated with each other.

4. The guidance system according to claim 1,
wherein the guidance map includes communication circuity configured to receive unique identification information stored in the portable medium carried by the user, and
the user specifying circuitry specifies the user based on the unique identification information received by the communication circuity and the image.

5. The guidance system according to claim 1,
wherein, in a case where a group including the specified user is confirmed, the guidance presentation circuitry causes the guidance map to output the guidance information about the area within the range of the guidance target having an attribute with a higher degree of interest of the group.

6. The guidance system according to claim 5,
wherein, in a case where at least a preset number of the users belonging to the group are specified, the guidance presentation circuitry causes the guidance map to output the guidance information about the area within the range of the guidance target having the attribute with the higher degree of interest of the group.

7. The guidance system according to claim 5,
wherein, in a case where at least a preset proportion of the users belonging to the group are specified, the guidance presentation circuitry causes the guidance map to output the guidance information about the area within the range of the guidance target having the attribute with the higher degree of interest of the group.

8. The guidance system according to claim 1,
wherein the guidance system includes the guidance map including output circuitry configured to output the guidance information, and
the guidance presentation circuitry causes the output circuitry to output the guidance information.

9. The guidance system according to claim 8,
wherein the guidance map includes the guidance presentation circuitry.

10. The guidance system according to claim 8, further comprising:
a server device that is connectable to the guidance map via a network,
wherein the server device includes the interest information storage medium and the guidance presentation circuitry, and
the guidance presentation circuitry causes the output circuitry of the guidance map to output the guidance information via the network.

11. The guidance system according to claim 1, further comprising:
a first imaging device that is the imaging device configured to image the user near the guidance map;
a plurality of second imaging devices installed in a building within the range of the guidance target;
floor determination circuitry configured to determine an arrival floor of the user among a plurality of floors in the building based on an image captured by at least any of the plurality of second imaging devices while the user is moving;
behavior information acquisition circuitry configured to acquire behavior information representing behavior of the user on the arrival floor determined by the floor determination circuitry, based on the image captured by at least any of the plurality of second imaging devices; and
interest information acquisition circuitry configured to acquire the interest information representing a degree of interest of the user for each attribute based on disposition and the attribute of the area on the arrival floor determined by the floor determination circuitry and the behavior information acquired by the behavior information acquisition circuitry, and store the interest information in the interest information storage medium for each user.

12. (canceled)

13. The guidance system according to claim 1,
wherein the guidance map arranges the taxi, including a user headcount of the group to which the user belongs.

14. A guidance system comprising:
user specifying circuitry configured to, based on an image captured by an imaging device configured to image a user near a guidance map that includes a display and a processor and provides guidance about a guidance target, specify the user; and
guidance presentation circuitry configured to, based on interest information and an attribute of an area within a range of the guidance target, cause the guidance map to output guidance information about the area within the range of the guidance target having an attribute with a higher degree of interest of the user specified by the user specifying circuitry,
wherein the guidance information represents a degree of interest of the user, is acquired from an interest information storage medium configured to store the interest information, and corresponds to the user specified by the user specifying circuitry,
the attribute is acquired from an attribute information storage medium configured to store the attribute for each area, and
the guidance map includes operation circuitry of the guidance map, and automatically registers a destination designated in accordance with a request of the user via the operation circuitry or a portable medium carried by the user, as a destination of a shared vehicle.

15. The guidance system according to claim 14,
wherein the guidance map automatically registers the designated destination as the destination of the shared vehicle, generates an optimal movement route corresponding to the destination of the shared vehicle, and sets the generated movement route in the shared vehicle.

16. The guidance system according to claim 15,
wherein the designated destination includes a destination indicated by the guidance information output by the guidance map, and
the guidance map automatically registers a destination designated from the guidance information via the operation circuitry or the portable medium carried by each of a plurality of the users, as the destination of the shared vehicle.

17. The guidance system according to claim 16,
wherein the designated destination includes a designated place of which positional information is directly designated via the operation circuitry or the portable medium, and
in a case where the designated destination is the designated place, the guidance map automatically registers the designated place as the destination of the shared vehicle, and stops output of the guidance information corresponding to the user who has designated the designated place.

18. The guidance system according to claim 17,
wherein the guidance map displays a current position of the shared vehicle, planned waypoints, and the movement route, and displays the current position of the shared vehicle, the planned waypoints, and the movement route on the portable medium.

19. The guidance system according to claim 18,
wherein the guidance map stops display of part or entirety of the waypoints and the movement route in accordance with an operation of the operation circuitry or the portable medium.

20. A guidance method of a guidance system configured to output guidance information to a guidance map that includes a display and a processor and provides guidance about a guidance target, the guidance method comprising:
via user specifying circuitry, based on an image captured by an imaging device configured to image a user near the guidance map, specifying the user; and
via guidance presentation circuitry, based on interest information and an attribute of an area within a range of the guidance target, causing the guidance map to output the guidance information about the area within the range of the guidance target having an attribute with a higher degree of interest of the user specified by the user specifying circuitry,
wherein the guidance information represents a degree of interest of the user, is acquired from an interest information storage medium configured to store the interest information, and corresponds to the user specified by the user specifying circuitry,
the attribute is acquired from an attribute information storage medium configured to store the attribute for each area, and
the guidance map includes operation circuitry of the guidance map, and automatically registers a destination designated via the operation circuitry or a portable medium carried by the user, as a destination of a taxi.

21. (canceled)

22. The guidance method according to claim 20,
wherein the guidance map arranges the taxi, including a user headcount of the group to which the user belongs.

23. A guidance method of a guidance system configured to output guidance information to a guidance map that includes a display and a processor and provides guidance about a guidance target, the guidance method comprising:
via user specifying circuitry, based on an image captured by an imaging device configured to image a user near the guidance map, specifying the user; and
via guidance presentation circuitry, based on interest information and an attribute of an area within a range of the guidance target, causing the guidance map to output the guidance information about the area within the range of the guidance target having an attribute with a higher degree of interest of the user specified by the user specifying circuitry,
wherein the guidance information represents a degree of interest of the user, is acquired from an interest information storage medium configured to store the interest information, and corresponds to the user specified by the user specifying circuitry,
the attribute is acquired from an attribute information storage medium configured to store the attribute for each area, and
wherein the guidance map includes operation circuitry of the guidance map, and automatically registers a destination designated in accordance with a request of the user via the operation circuitry or a portable medium carried by the user, as a destination of a shared vehicle.

24. The guidance method according to claim 23,
wherein the guidance map automatically registers the designated destination as the destination of the shared vehicle, generates an optimal movement route corresponding to the destination of the shared vehicle, and sets the generated movement route in the shared vehicle.

25. The guidance method according to claim 24,
wherein the designated destination includes a destination included in the guidance information, and
the guidance map automatically registers a destination designated via the operation circuitry or the portable medium carried by each of a plurality of the users, as the destination of the shared vehicle.

26. The guidance method according to claim 25,
wherein the designated destination includes a designated place of which positional information is directly designated via the operation circuitry or the portable medium, and
in a case where the designated destination is the designated place, the guidance map automatically registers the designated place as the destination of the shared vehicle, and stops output of the guidance information corresponding to the user who has designated the designated place.

27. The guidance method according to claim 26,
wherein the guidance map displays a current position of the shared vehicle, planned waypoints, and the movement route, and displays the current position of the shared vehicle, the planned waypoints, and the movement route on the portable medium.

28. The guidance method according to claim 27,
wherein the guidance map stops display of part or entirety of the waypoints and the movement route in accordance with an operation of the operation circuitry or the portable medium.
